(19) United States
(12) Patent Application Publication
(10) Pub. No.: US 2026/0221643 A1
(43) Pub. Date: Jul. 30, 2026

(54) ANTENNA MODULE ARRANGED ON VEHICLE

(71) Applicant: LG ELECTRONICS INC., Seoul (KR)

(72) Inventors: Kukheon CHOI, Seoul (KR); Woocheol CHOI, Seoul (KR); Kangjae JUNG, Seoul (KR); Dongjin KIM, Seoul (KR); Byeongyong PARK, Seoul (KR)

(73) Assignee: LG ELECTRONICS INC., Seoul (KR)

(21) Appl. No.: 19/147,492

(22) PCT Filed: Jan. 11, 2023
(86) PCT No.: PCT/KR2023/000469

§ 371 Date: Jul. 11, 2025

(51) Int. Cl. H01Q 1/12; H01Q 13/10

(52) U.S. Cl. CPC H01Q 1/1271; H01Q 13/10

(57) ABSTRACT

This vehicle comprises a glass panel and an antenna assembly. The antenna assembly includes first and second dielectric substrates. The antenna assembly can include: a first conductive pattern; and a slot pattern arranged in parallel to the outer boundary of the first conductive pattern or the inner boundary of the first conductive pattern so as to reflect signals of a specific frequency band. The slot pattern can include: a first slot pattern which is formed to have a first slot length in a first axis direction and which reflects signals in the opposite direction thereof on a first axis; and a second slot pattern connected to the first slot pattern and formed to have a second slot length in a second axis direction.

### TECHNICAL FIELD

This specification relates to an antenna module arranged on a vehicle. One specific embodiment relates to an interference reduction structure capable of reducing interference between antenna elements.

### BACKGROUND ART

A vehicle may perform wireless communication services with other vehicles, nearby objects, infrastructures, or a base station. In this regard, various communication services may be provided through a wireless communication system to which an LTE communication technology or a 5G communication technology is applied. Meanwhile, some of LTE frequency bands may be allocated for 5G communication services.

A vehicle body and roof are formed of metallic material, which causes a problem with blocking radio waves. Accordingly, a separate antenna structure may be arranged on top of the vehicle body or the vehicle roof. Alternatively, when the antenna structure is arranged below the vehicle body or roof, a portion of the vehicle body or roof corresponding to an antenna arrangement region may be formed of a non-metallic material.

However, in terms of design, the vehicle body or roof needs to be integrally formed. In this case, the exterior of the vehicle body or roof may be formed of a metallic material. This may cause antenna efficiency to be drastically lowered due to the vehicle body or roof.

In relation to this, to increase a communication capacity without a change in the exterior design of the vehicle, a transparent antenna may be arranged on glass corresponding to a window of the vehicle. However, antenna radiation efficiency and impedance bandwidth characteristics are deteriorated due to electrical loss of the transparent antenna.

An antenna assembly for a vehicle implemented as such a transparent antenna may be configured to perform 4G wireless communications and 5G wireless communications. The antenna assembly for the vehicle needs to be configured to perform Wi-Fi and Bluetooth (BT) wireless communications in addition to the 4G and 5G wireless communications. There is a problem in that the overall size of the antenna assembly increases when an antenna module configured to perform Wi-Fi and Bluetooth (BT) wireless communications is configured separately from an antenna module performing 4G wireless communications and 5G wireless communications.

To address these issues, Wi-Fi/BT antennas may be arranged in the same structure to be adjacent to 4G/5G antennas. However, as the Wi-Fi/BT antennas are arranged in the same structure, interference between 4G/5G antennas and Wi-Fi/BT antennas may increase.

### DISCLOSURE OF INVENTION

### Technical Problem

One aspect of the specification is to solve the aforementioned problems and other drawbacks. Another aspect of the specification is to provide a structure of reducing interference between antennas in a broadband transparent antenna assembly which may be arranged on vehicle glass.

Another aspect of the specification is to provide a Wi-Fi antenna structure and an interference reduction structure, which may coexist with a transparent antenna, by considering the arrangement structure of the transparent antenna arranged on vehicle glass.

Another aspect of the specification is to provide an RF choke structure, which may be designed smaller than existing RF chokes and operate bidirectionally.

Another aspect of the specification is to provide an RF choke arrangement structure that is capable of improving the performance of a Wi-Fi antenna by considering isolation according to a current flow between a 4G/5G MIMO antenna and the Wi-Fi antenna.

### Solution to Problem

To achieve these and other advantages and in accordance with the purpose of this specification, as embodied and broadly described herein, a vehicle includes a glass panel and an antenna assembly. The antenna assembly may include first and second dielectric substrates. The antenna assembly may include a first conductive pattern and a slot pattern arranged parallel to an outer boundary of the first conductive pattern or an inner boundary of the first conductive pattern and configured to reflect a signal of a specific frequency band. The slot pattern may include a first slot pattern formed with a first slot length in the first axial direction and configured to reflect the signal in an opposite direction on the first axis; and a second slot pattern connected to the first slot pattern and formed with a second slot length in the second axial direction.

In an embodiment, the glass panel may include a transparent region and an opaque region. The antenna assembly may be arranged on the glass panel. The antenna assembly may include: a first dielectric substrate arranged in the transparent region of the glass panel, and including a transparent antenna formed on one side surface thereof; a second dielectric substrate arranged in the opaque region of the glass panel; a first conductive pattern formed on the second dielectric substrate; a second conductive pattern formed by being spaced apart from an outer boundary of the first conductive pattern or an inner boundary of the first conductive pattern by a gap region; and a slot pattern arranged parallel to the outer boundary of the first conductive pattern or the inner boundary of the first conductive patterns and configured to reflect a signal of a specific frequency band. The slot pattern may further include a third slot pattern connecting a point on an inner side of the first slot pattern or the second slot pattern and the gap region.

In an embodiment, the third slot pattern may be formed to connect a point of the first slot pattern and the gap region. The slot pattern may further include: a fourth slot pattern arranged parallel to the second slot pattern between the first conductive pattern and the second slot pattern; and a fifth slot pattern connecting a point on an inner side of the fourth slot pattern and the gap region.

In an embodiment, the first conductive pattern may include a first sub-pattern formed in the first axial direction, and a second sub-pattern connected to the first sub-pattern and formed in the second axial direction. The first slot pattern to the third slot pattern may be arranged on the second conductive pattern spaced apart from the outer boundary of the first conductive pattern.

In an embodiment, the first conductive pattern may include a first sub-pattern formed in the first axial direction, and a second sub-pattern connected to the first sub-pattern and formed in the second axial direction. The conductive pattern may further include a third conductive pattern formed spaced apart from inner boundaries of the first sub-pattern and the second sub-pattern. The first slot pattern to the third slot pattern may be arranged on the third conductive pattern spaced apart from the inner boundary of the first conductive pattern.

In an embodiment, the antenna assembly may include: a via hole arranged in a region between the second slot pattern and the third slot pattern and the gap region, and vertically connecting a conductive pattern formed on a rear surface of the second dielectric substrate; and a metal stub arranged on the rear surface of the second dielectric substrate and connected to the via hole. The metal stub may include: a third sub-pattern formed with a third length in the first axial direction; and a fourth sub-pattern connected to the third sub-pattern and formed with a fourth length in the second axial direction.

In an embodiment, the via hole may be arranged between an upper region of the first sub-pattern and a lower region of the first slot pattern.

In an embodiment, the via hole may be arranged between a lower region of the first sub-pattern and an upper region of the first slot pattern.

In an embodiment, the transparent antenna may include a first transparent antenna and a second transparent antenna. The second dielectric substrate may include: a first ground region and a second ground region comprising a first feeding pattern and a second feeding pattern configured to feed power to the first transparent antenna and the second transparent antenna; and a slot antenna region arranged between the first ground region and the second ground region and comprising a plurality of slot radiator patterns formed on the first conductive pattern. The plurality of slot radiator patterns arranged in the slot antenna region may operate as a third antenna.

In an embodiment, the slot antenna region may include: a first slot region formed in the second axial direction on the first conductive pattern and configured to be coupled with a signal line of a coaxial cable; and a second slot region connected to one side of the first slot region and formed in the first axial direction. The slot antenna region may be configured to radiate Wi-Fi signals of a first frequency band and a second frequency band.

In an embodiment, the slot pattern may be formed in the first ground region and the second ground region to suppress a signal of the same band as the Wi-Fi signal from being transmitted from the first ground region and the second ground region to the slot antenna region. The slot pattern may be formed in the slot antenna region to block the Wi-Fi signal from being transmitted from the slot antenna region to the first ground region and the second ground region.

A vehicle according to another aspect of the present disclosure includes a glass panel having a transparent region and an opaque region, and an antenna assembly arranged on the glass panel. The antenna assembly may include: a first dielectric substrate arranged in the transparent region of the glass panel, and including a first transparent antenna and a second transparent antenna formed on one side surface thereof; a second dielectric substrate including a first ground region and a second ground region, and arranged in the opaque region of the glass panel; and a slot pattern arranged on a conductive pattern of the first ground region and the second ground region, and configured to reflect a signal of a specific frequency band. The slot pattern may include: a first slot pattern formed with a first slot length in a first axial direction and configured to reflect the signal in an opposite direction on the first axis; a second slot pattern connected to the first slot pattern and formed with a second slot length in a second axial direction; and a third slot pattern connecting a point on an inner side of the first slot pattern or the second slot pattern and the gap region.

In an embodiment, the third slot pattern may be formed to connect a point of the first slot pattern and the gap region. The slot pattern may further include: a fourth slot pattern arranged parallel to the second slot pattern between a first conductive pattern and the second slot pattern; and a fifth slot pattern connecting a point on an inner side of the fourth slot pattern and the gap region.

In an embodiment, the first conductive pattern may include a first sub-pattern formed in the first axial direction, and a second sub-pattern connected to the first sub-pattern and formed in the second axial direction. The first slot pattern to the third slot pattern may be arranged on a second conductive pattern spaced apart from the outer boundary of the first conductive pattern.

In an embodiment, the first conductive pattern may include a first sub-pattern formed in the first axial direction, and a second sub-pattern connected to the first sub-pattern and formed in the second axial direction. The conductive pattern may further include a second conductive pattern and a third conductive pattern formed spaced apart from outer boundaries and inner boundaries of the first sub-pattern and the second sub-pattern. The first slot pattern to the third slot pattern may be arranged on the third conductive pattern spaced apart from the inner boundary of the first conductive pattern.

In an embodiment, the antenna assembly may include: a via hole arranged in a region between the second slot pattern and the third slot pattern and the gap region, and vertically connecting a conductive pattern formed on a rear surface of the second dielectric substrate; and a metal stub arranged on the rear surface of the second dielectric substrate and connected to the via hole. The metal stub may include: a first metal stub formed with a first stub length in the first axial direction; and a second metal stub connected to the first metal stub and formed with a second stub length in the second axial direction.

In an embodiment, the via hole may be arranged between an upper region of the first sub-pattern and a lower region of the first slot pattern.

In an embodiment, the via hole may be arranged between a lower region of the first sub-pattern and an upper region of the first slot pattern.

In an embodiment, the second dielectric substrate may include: the first ground region and the second ground region comprising a first feeding pattern and a second feeding pattern configured to feed power to the first transparent antenna and the second transparent antenna; and a slot antenna region arranged between the first ground region and the second ground region and comprising a plurality of slot radiator patterns. The plurality of slot radiator patterns arranged in the slot antenna region may operate as a third antenna.

In an embodiment, the slot antenna region may include: a first slot region formed in the second axial direction on the first conductive pattern and configured to be coupled with a signal line of a coaxial cable; and a second slot region connected to one side of the first slot region and formed in the first axial direction. The slot antenna region may be configured to radiate Wi-Fi signals of a first frequency band and a second frequency band.

In an embodiment, the slot pattern may be formed in the first ground region and the second ground region to suppress the Wi-Fi signal from being transmitted from the first ground region and the second ground region to the slot antenna region. The slot pattern may be formed in the slot antenna region to block the Wi-Fi signal from being transmitted from the slot antenna region to the first ground region and the second ground region.

### Advantageous Effects of Invention

Hereinafter, the technical effects of the interference reduction structure including the RF chokes implemented with slot patterns that reduce interference between antenna elements in an antenna assembly that will be described.

According to the specification, interferences between antennas may be reduced through an RF-choke structure implemented with slot patterns in a broadband transparent antenna assembly which may be arranged on vehicle glass.

According to the specification, a Wi-Fi antenna structure, which may coexist with a transparent antenna, and an interference reduction structure including RF chokes implemented with slot patterns may be provided by considering the arrangement structure of the transparent antenna arranged on vehicle glass.

According to the specification, a two-dimensional RF Choke structure may be provided that is designed to be smaller than existing RF chokes and is implemented to be operable bidirectionally on a two-dimensional plane.

According to the specification, an RF-choke structure operable in a single Wi-Fi frequency band may be implemented by a combination of first and second slot patterns or a combination of first to third slot patterns.

According to the specification, an RF-choke structure capable of operating in a dual Wi-Fi frequency band may be implemented by combining fourth and fifth slot patterns with a structure capable of operating in a single frequency band.

According to the specification, two-dimensional RF choke structures may be provided at corners of ground regions adjacent to feeding patterns, taking into account isolation according to a current flow between a 4G/5G MIMO antenna and a Wi-Fi antenna.

According to the specification, an RF choke arrangement structure which is capable of improving the performance of the Wi-Fi antenna through the two-dimensional RF choke structures at the corners of the ground regions can be provided.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

### BRIEF DESCRIPTION OF DRAWINGS

FIG. 1 is a diagram of vehicle glass on which an antenna structure according to an embodiment is to be arranged.

FIG. 2A is a front view of the vehicle of FIG. 1, which has an antenna assembly arranged in different regions of front glass.

FIG. 2B is a front perspective view of the inside of the vehicle of FIG. 1, which has the antenna assembly arranged in the different regions of the front glass.

FIG. 2C is a lateral perspective view of the vehicle of FIG. 1, which has the antenna assembly arranged on upper glass.

FIG. 3 illustrates types of V2X applications.

FIG. 4 is a block diagram referenced for explaining a vehicle and an antenna system mounted on the vehicle according to an embodiment of the disclosure.

FIGS. 5A to 5C are views of a configuration that an antenna assembly according to the disclosure is arranged on vehicle glass.

FIG. 6A is a view of various embodiments of a frit pattern according to the disclosure. FIGS. 6B and 6C are views of transparent antenna patterns according to embodiments and structures in which the corresponding transparent antenna pattern is arranged on vehicle glass.

FIG. 7A is a view of a front side and a cross-section of a transparent antenna assembly according to the disclosure. FIG. 7B is a view of a grid structure of a metal mesh radiator region and a dummy metal mesh region according to embodiments.

FIG. 8A is a view of a layered structure of an antenna module and a feeding module. FIG. 8B is a view of an opaque substrate including a layered structure, in which the antenna module and the feeding structure are coupled to each other, and a coupling region.

FIG. 9A is a view of a coupling structure of a transparent antenna that is arranged in a transparent region and a frit region of vehicle glass.

FIG. 9B is an enlarged front view of a region where glass with the transparent antenna of FIG. 9A is coupled to a body structure of the vehicle. FIG. 9C is a cross-sectional view of the coupling structure between the vehicle glass and the body structure of FIG. 9B, viewed from different positions.

FIG. 10 is a view of a stacked structure of an antenna assembly and an attachment region between vehicle glass and a vehicle frame according to embodiments.

FIG. 11A is a view of an RF choke structure implemented as a slot pattern arranged adjacent to a boundary on one side of a conductive pattern constituting an antenna assembly.

FIG. 11B is a cross-sectional view of a dielectric substrate formed along line a-a′ of FIG. 11A.

FIG. 11C is a view of an equivalent circuit of the RF choke of FIG. 11A.

FIG. 12A is a view of a layer structure of an RF choke formed in an outer region of a conductive pattern.

FIG. 12B is a view of a layer structure of an RF choke formed in an inner region of the conductive pattern.

FIG. 12C is a view of an RF choke structure implemented in both outer and inner regions of a first conductive pattern.

FIG. 13A is a view of current distribution and isolation characteristics of the RF choke structure arranged in the outer region of the first conductive pattern.

FIG. 13B is a view of current distribution and isolation characteristics of the RF choke structure arranged in the inner region of the first conductive pattern.

FIGS. 14A and 14B are views of arrangements of RF chokes which are arranged in the outer region and the inner region of the first conductive pattern and operate in a dual band.

FIG. 15A is a view of current distribution and isolation characteristics of the RF choke structure which is arranged in the outer region of the first conductive pattern and operates in the dual band.

FIG. 15B is a view of current distribution and isolation characteristics of the RF choke structure which is arranged in the inner region of the first conductive pattern and operates in the dual band.

FIGS. 16A and 16B are views of shapes and structures of inner-form RF chokes, which are implemented as slot patterns, according to embodiments.

FIGS. 17A and 17B are views of shapes and structures of outer-form RF chokes, which are implemented as slot patterns, according to embodiments.

FIG. 18A is a conceptual view in which a current of a Wi-Fi antenna arranged between transparent antennas causes interference with the adjacent transparent antennas.

FIG. 18B is a view of RF chokes arranged adjacent to slot patterns of a Wi-Fi antenna arranged between transparent antennas.

FIG. 19A is a view of regions where RF chokes implemented as slot patterns may be formed on a dielectric substrate which feeds power to transparent antennas.

FIG. 19B is a view of RF chokes formed on a dielectric substrate which feeds power to transparent antennas.

FIG. 20 is a view of an antenna assembly having first and second transparent antennas implemented with a plurality of conductive patterns.

FIG. 21 is a view of an example of a configuration in which a plurality of antenna modules arranged at different positions of a vehicle are coupled with other components of the vehicle.

### MODE FOR THE INVENTION

A description will now be given in detail according to one or more embodiments disclosed herein, with reference to the accompanying drawings. For the sake of a brief description with reference to the drawings, the same or like components regardless reference numerals may be assigned the same reference numeral, and a redundant description thereof will be omitted. Suffixes “module” and “unit” used for components used in the following description are merely intended for easy description of the specification, and each suffix itself is not intended to give any special meaning or function. In describing the embodiments disclosed herein, moreover, the detailed description will be omitted when a specific description for publicly known technologies to which the disclosure pertains is judged to obscure the gist of the disclosure. The accompanying drawings are used to help easily understand various technical features, and it should be understood that the embodiments presented herein are not limited by the accompanying drawings. As such, the disclosure should be construed to extend to any alterations, equivalents, and substitutes in addition to those which are particularly set forth in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

The singular forms are intended to include the plural forms as well, unless the context clearly indicates otherwise.

Terms “include” or “has” as used herein should be understood that they are intended to indicate the existence of a feature, a number, a step, an element, a component, or a combination thereof disclosed in the specification, and it may also be understood that the existence or additional possibility of one or more other features, numbers, steps, elements, components, or combinations thereof are not excluded in advance.

An antenna system described herein may be mounted on a vehicle. Configurations and operations according to embodiments may also be applied to a communication system, namely, an antenna system mounted on a vehicle. In this regard, the antenna system mounted on the vehicle may include a plurality of antennas, and a transceiver circuit and a processor both configured to control the plurality of antennas.

Hereinafter, a description will be given of an antenna assembly (antenna module) that may be arranged on a window of a vehicle according to the disclosure, and an antenna system for a vehicle that includes the antenna assembly. In this regard, the antenna assembly may refer to a structure in which conductive patterns are combined on a dielectric substrate, and may also be referred to as an antenna module.

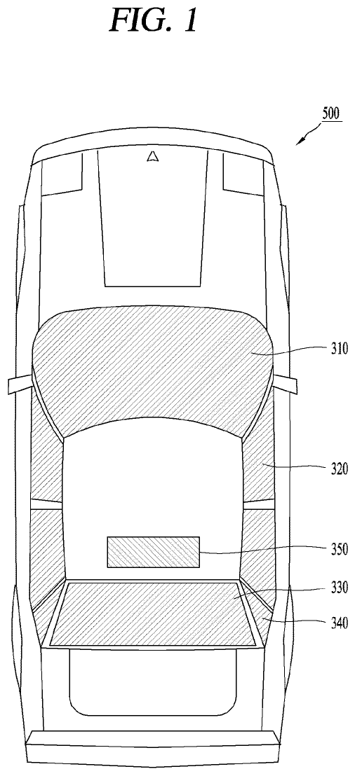

In some embodiments, FIG. 1 is a view of vehicle glass on which an antenna structure according to an embodiment of the disclosure is to be arranged. Referring to FIG. 1, a vehicle 500 may include front glass 310, door glass 320, rear glass 330, and quarter glass 340. In some examples, the vehicle 500 may further include top glass 350 arranged on a roof in an upper region.

Therefore, the glass constituting the window of the vehicle 500 may include the front glass 310 arranged in a front region of the vehicle, the door glass 320 arranged in a door region of the vehicle, and the rear glass 330 arranged in a rear region of the vehicle. In some examples, the glass constituting the window of the vehicle 500 may further include the quarter class 340 arranged in a partial region of the door region of the vehicle. In addition, the glass constituting the window of the vehicle 500 may further include the top glass 350 spaced apart from the rear glass 330 and arranged in an upper region of the vehicle. Accordingly, each glass constituting the window of the vehicle 500 may also be referred to as a window.

The front glass 310 may be referred to as a front windshield because it suppresses wind blown from a front side from entering the inside of the vehicle. The front glass 310 may have a two-layer bonding structure having a thickness of about 5.0 to 5.5 mm. The front glass 310 may have a bonding structure of glass/shatterproof film/glass.

The door glass 320 may have a two-layer bonding structure or may be formed of single-layer compressed glass. The rear glass 330 may have a two-layer bonding structure having a thickness of about 3.5 to 5.5 mm or may be formed of single-layer compressed glass. In the rear glass 330, a spaced distance may be required between a transparent antenna and a heat line and AM/FM antenna. The quarter glass 340 may be formed of single-layer compressed glass with a thickness of about 3.5 to 4.0 mm, but is not limited thereto.

The size of the quarter glass 340 may vary depending on a type of vehicle, and may have a size smaller than the sizes of the front glass 310 and the rear glass 330.

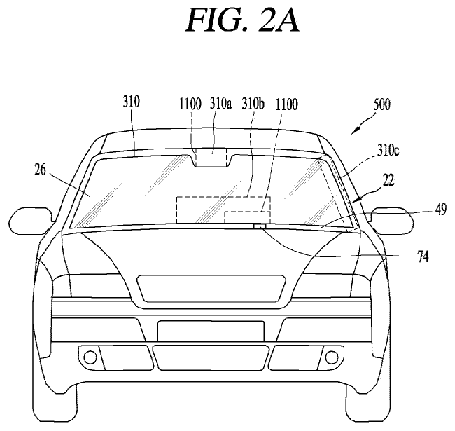

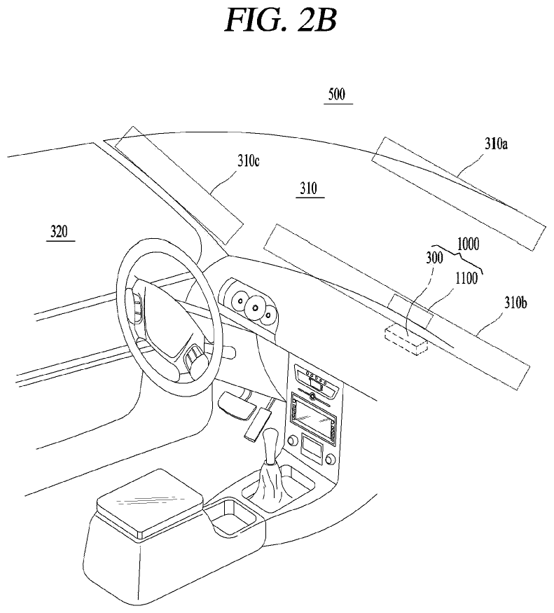

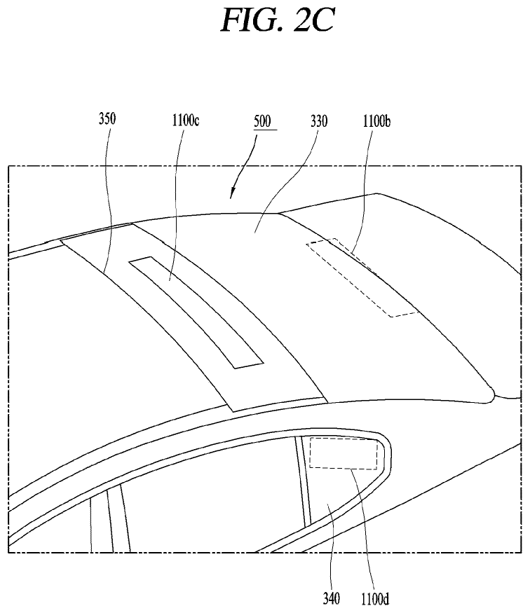

Hereinafter, a structure in which an antenna assembly according to the disclosure is arranged in different regions of the front glass of a vehicle will be described. An antenna assembly attached to vehicle glass may be implemented as a transparent antenna. In this regard, FIG. 2A is a front view of the vehicle of FIG. 1, which has an antenna assembly arranged in different regions of the front glass. FIG. 2B is a front perspective view illustrating the inside of the vehicle of FIG. 1, which has the antenna assembly arranged in the different regions of the front glass. FIG. 2C is a lateral perspective view of the vehicle of FIG. 1, which has the antenna assembly arranged on upper glass.

Referring to FIG. 2A which is the front view of the vehicle 500, a configuration in which the transparent antenna for the vehicle according to the specification may be arranged is illustrated. A pane assembly 22 may include an antenna arranged in an upper region 310a. The pane assembly 22 may include an antenna in the upper region 310a, an antenna in a lower region 310b, and/or an antenna in a side region 310c. The pane assembly 22 may also include translucent pane glass 26 formed of a dielectric substrate. The antenna in the upper region 310a, the antenna in the lower region 310b, and/or the antenna in the side region 310c may be configured to support any one or more of various communication systems.

An antenna module 1100 may be arranged in the upper region 310a, the lower region 310b, or the side region 310c of the front glass 310. When the antenna module 1100 is arranged in the lower region 310b of the front glass 310, the antenna module 1100 may extend to a body 49 of a lower region of the translucent pane glass 26. The body 49 of the lower region of the translucent pane glass 26 may have lower transparency than other portions. A portion of a feeder and other interface lines may be arranged on the body 49 of the lower region of the translucent pane glass 26. A connector assembly 74 may be implemented on the body 49 of the lower region of the translucent pane glass 26. The body 49 of the lower region may constitute a vehicle body made of a metal material.

Referring to FIG. 2B, an antenna assembly 1000 may include a telematics control unit (TCU) 300 and an antenna module 1100. The antenna module 1100 may be located in a different region of glass of the vehicle.

Referring to FIGS. 2A and 2B, the antenna assembly may be arranged in the upper region 310a, the lower region 310b, and/or the side region 310c of the vehicle glass. Referring to FIGS. 2A to 2C, the antenna assembly may be arranged on the front glass 310, rear glass 330, quarter glass 340, and upper glass 350 of the vehicle.

Referring to FIGS. 2A to 2C, the antenna arranged in the upper region 310a of the front glass 310 of the vehicle may be configured to operate in a low band LB, a mid band (MB), a high band (HB), and a 5G Sub6 band of 4G/5G communication systems. The antenna in the lower region 310b and/or the antenna in the side region 310c may also be configured to operate in the LB, MB, HB, and 5G Sub6 band of the 4G/5G communication systems. An antenna structure 1100b on the rear glass 330 of the vehicle may also be configured to operate in the LB, MB, HB, and 5G Sub6 band of the 4G/5G communication systems. An antenna structure 1100c on the upper glass 350 of the vehicle may also be configured to operate in the LB, MB, HB, and 5G Sub6 band of the 4G/5G communication systems. An antenna structure 1100d on the quarter glass 350 of the vehicle may also be configured to operate in the LB, MB, HB, and 5G Sub6 band of the 4G/5G communication systems.

At least a portion of an outer region of the front glass 310 of the vehicle may be defined by the translucent pane glass 26. The translucent pane glass 26 may include a first part in which an antenna and a portion of a feeder are formed, and a second part in which another portion of the feeder and a dummy structure are formed. The translucent pane glass 26 may further include a dummy region in which conductive patterns are not formed. For example, a transparent region of the translucent pane glass 22 may be transparent to secure light transmission and a field of view.

Although it is exemplarily illustrated that conductive patterns may be formed in a partial region of the front glass 310, the conductive patterns may extend to the side glass 320 and the rear glass 330 of FIG. 1, and an arbitrary glass structure. In the vehicle 500, the occupants or driver may view road and surrounding environment through the pane assembly 22. In addition, the occupants or driver may view the road and surrounding environment without interference by the antenna in the upper region 310a, the antenna in the lower region 310b, and/or the antenna in the side region 310c.

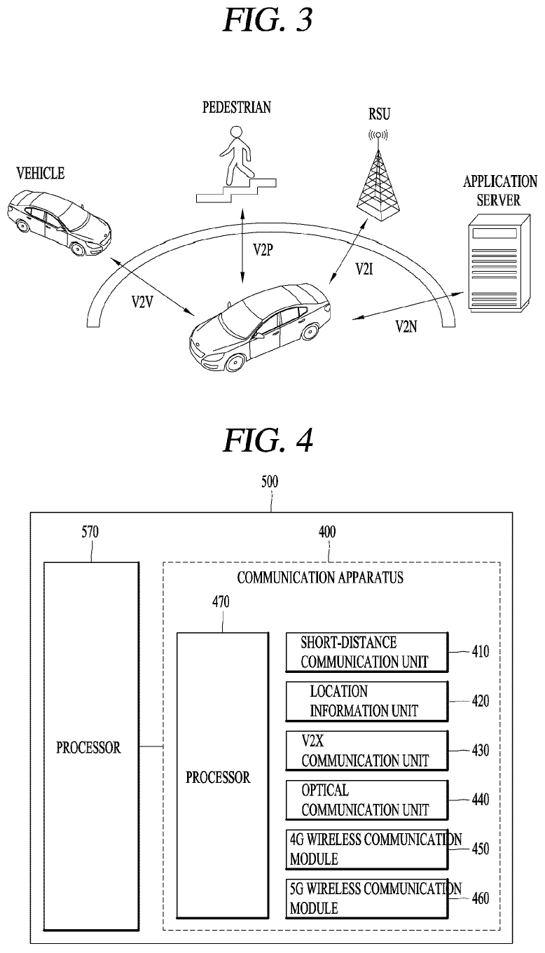

The vehicle 500 may be configured to communicate with pedestrians, adjacent infrastructures, and/or servers in addition to adjacent vehicles. FIG. 3 illustrates types of V2X applications. Referring to FIG. 3, V2X communications may include communications between a vehicle and all entities, such as V2V (vehicle-to-vehicle) which refers to communication between vehicles, V2I (vehicle-to-infrastructure) which refers to communication between a vehicle and an eNB or RSU (road side unit), V2P (vehicle-to-pedestrian) which refers to communication between a vehicle and a terminal possessed by a person (pedestrian, cyclist, vehicle driver, or passenger), V2N (vehicle-to-network), and the like.

In some embodiments, FIG. 4 is a block diagram referenced for explaining a vehicle and an antenna system mounted in the vehicle according to an embodiment of the disclosure.

The vehicle 500 may include a communication device 400 and a processor 570. The communication device 400 may correspond to the telematics control unit (TCU) of the vehicle 500.

The communication device 400 may be a device for performing communication with an external device. Here, the external device may be another vehicle, a mobile terminal, or a server. The communication device 400 may perform the communication by including at least one of a transmitting antenna, a receiving antenna, a radio frequency (RF) circuit, and an RF device for implementing various communication protocols. In this regard, the communication device 400 may include a short-range communication unit 410, a location information unit 420, a V2X communication unit 430, an optical communication unit 440, a 4G wireless communication module 450, and a 5G wireless communication module 460. The communication device 400 may include a processor 470. According to an embodiment, the communication device 400 may further include other components in addition to the components described, or may not include some of the components described.

The 4G wireless communication module 450 and the 5G wireless communication module 460 may perform wireless communications with one or more communication systems through one or more antenna modules. The 4G wireless communication module 450 may transmit and/or receive signals to and/or from a device in a first communication system through a first antenna module. Also, the 5G wireless communication module 460 may transmit and/or receive signals to and/or from a device in a second communication system through a second antenna module. The 4G wireless communication module 450 and 5G wireless communication module 460 may also be physically implemented as one integrated communication module. For example, the first communication system and the second communication system may be an LTE communication system and a 5G communication system, respectively. However, the first communication system and the second communication system may not be limited thereto, and may expand to any different communication systems.

The processor of the device within the vehicle 500 may be implemented as a micro control unit (MCU) or a modem. The processor 470 of the communication device 400 may correspond to a modem, and the processor 470 may be implemented as an integrated modem. The processor 470 may acquire surrounding information from other adjacent vehicles, objects, or infrastructures through wireless communication. The processor 470 may perform vehicle control using the acquired surrounding information.

The processor 570 of the vehicle 500 may be a processor of a car area network (CAN) or advanced driving assistance system (ADAS), but is not limited thereto. When the vehicle 500 is implemented in a distributed control manner, the processor 570 of the vehicle 500 may be replaced with a processor of each device.

In some examples, the antenna module arranged in the vehicle 500 may include a wireless communication unit. The 4G wireless communication module 450 may perform transmission and reception of 4G signals with a 4G base station through a 4G mobile communication network. In this instance, the 4G wireless communication module 450 may transmit at least one 4G transmission signal to the 4G base station. In addition, the 4G wireless communication module 450 may receive at least one 4G reception signal from the 4G base station. In this regard, uplink (UL) multi-input/multi-output (MIMO) may be performed based on a plurality of 4G transmission signals transmitted to the 4G base station. In addition, downlink (DL) MIMO may be performed based on a plurality of 4G reception signals received from the 4G base station.

The 5G wireless communication module 460 may perform transmission and reception of 5G signals with a 5G base station through a 5G wireless communication network. Here, the 4G base station and the 5G base station may have a non-stand-alone (NSA) architecture. The 4G base station and the 5G base station may be arranged, for example, in the non-stand-alone (NSA) architecture. In another example, the 5G base station may be arranged in a stand-alone (SA) architecture at a separate location from the 4G base station. The 5G wireless communication module 460 may perform transmission and reception of 5G signals with a 5G base station through a 5G wireless communication network. In this instance, the 5G wireless communication module 460 may transmit at least one 5G transmission signal to the 5G base station. In addition, the 5G wireless communication module 460 may receive at least one 5G reception signal from the 5G base station. In this instance, a 5G frequency band that is the same as a 4G frequency band may be used, and this may be referred to as LTE re-farming. In some examples, a Sub6 frequency band, which is a band of 6 GHz or less, may be used as the 5G frequency band. In contrast, a millimeter-wave (mmWave) band may be used as the 5G frequency band to perform wideband high-speed communication. When the mmWave band is used, the electronic device may perform beamforming for coverage expansion of an area where communication with a base station is possible.

Regardless of the 5G frequency band, in the 5G communication system, MIMO may be supported to be performed a plurality of times, to improve a transmission rate. In this instance, UL MIMO may be performed by a plurality of 5G transmission signals that are transmitted to a 5G base station. DL MIMO may be performed by a plurality of 5G reception signals that are received from the 5G base station.

In some examples, a state of dual connectivity (DC) with both the 4G base station and the 5G base station may be attained through the 4G wireless communication module 450 and the 5G wireless communication module 460. As such, the dual connectivity to the 4G base station and the 5G base station may be referred to as EUTRAN NR DC (EN-DC). In some examples, when the 4G base station and the 5G base station are arranged in a co-located structure, throughput improvement may be achieved by inter-carrier aggregation (inter-CA). Accordingly, when the 4G base station and the 5G base station are arranged in the EN-DC state, the 4G reception signal and the 5G reception signal may be simultaneously received through the 4G wireless communication module 450 and the 5G wireless communication module 460. Short-range communication between electronic devices (e.g., vehicles) may be performed between electronic devices (e.g., vehicles) using the 4G wireless communication module 450 and the 5G wireless communication module 460. In one embodiment, after resources are allocated, vehicles may perform wireless communication in a V2V manner without a base station.

In some embodiments, for transmission rate improvement and communication system convergence, carrier aggregation (CA) may be carried out using at least one of the 4G wireless communication module 450 and the 5G wireless communication module 460 and a WiFi communication module. In this regard, 4G+Wi-Fi carrier aggregation (CA) may be performed using the 4G wireless communication module 450 and the Wi-Fi communication module 113. Or, 5G+Wi-Fi CA may be performed using the 5G wireless communication module 460 and the Wi-Fi communication module.

In some examples, the communication device 400 may implement a display device for a vehicle together with a user interface device. In this instance, the display device for the vehicle may be referred to as a telematics apparatus or an audio video navigation (AVN) apparatus.

In some examples, a broadband transparent antenna structure that may be arranged on vehicle glass may be implemented with a single dielectric substrate on the same plane as a CPW feeder. In addition, the broadband transparent antenna structure that may be arranged on the vehicle glass may be implemented with a structure in which grounds are formed on both sides of a radiator, to constitute a broadband structure.

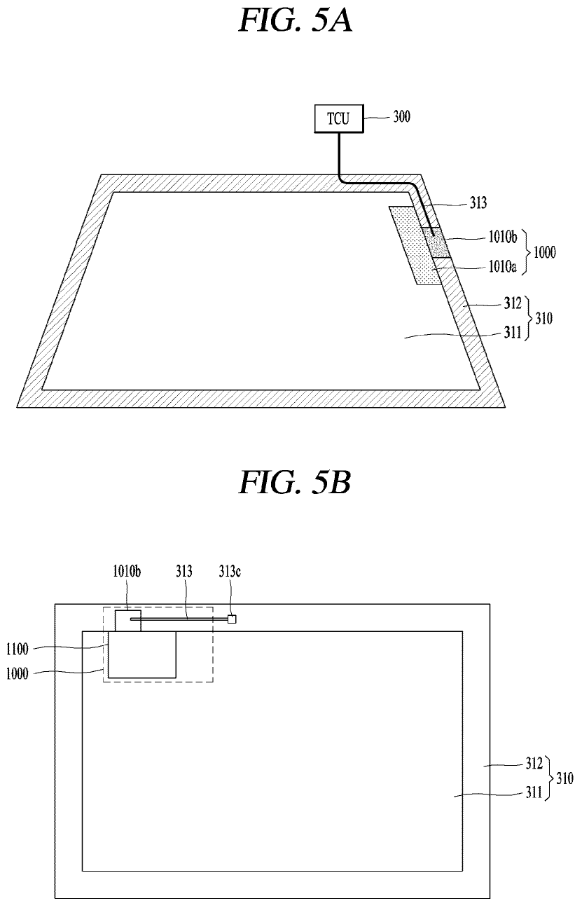

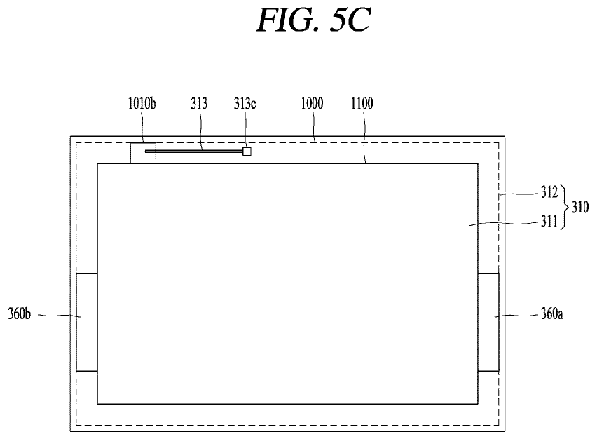

Hereinafter, an antenna assembly associated with a broadband transparent antenna structure according to the specification will be described. In this regard, FIGS. 5A to 5C are views of configurations in which an antenna assembly according to the specification is arranged on vehicle glass. Referring to FIG. 5A, the antenna assembly 1000 may include a first dielectric substrate 1010a and a second dielectric substrate 1010b. The first dielectric substrate 1010a may be implemented as a transparent substrate and thus may be referred to as a transparent substrate 1010a. The second dielectric substrate 1010b may be implemented as an opaque substrate 1010b.

The glass panel 310 may be configured to include a transparent region 311 and an opaque region 312. The opaque region 312 of the glass panel 310 may be a frit region formed as a frit layer. The opaque region 312 may be formed to surround the transparent region 311. The opaque region 312 may be formed outside the transparent region 311. The opaque region 312 may form a boundary region of the glass panel 310.

A signal pattern formed on a dielectric substrate 1010 may be connected to the telematics control unit (TCU) 300 through a connector part 313 such as a coaxial cable. The telematics control unit (TCU) 300 may be mounted inside the vehicle, but is not limited thereto. The telematics control unit (TCU) 300 may be arranged on a dashboard inside the vehicle or a ceiling region inside the vehicle, but is not limited thereto.

FIG. 5B is a view of a configuration in which the antenna assembly 1000 is arranged in a partial region of the glass panel 310. FIG. 5C is a view of a configuration in which the antenna assembly 1000 is arranged in an entire region of the glass panel 310.

Referring to FIGS. 5B and 5C, the glass panel 310 may include the transparent region 311 and the opaque region 312. The opaque region 312 that is a non-visible area with transparency below a certain level may be referred to as a frit region, black printing (BP) region, or black matrix (BM) region. The opaque region 312 corresponding to the non-visible area may be formed to surround the transparent region 311. The opaque region 312 may be formed in a region outside the transparent region 311. The opaque region 312 may form a boundary region of the glass panel 310. A second dielectric substrate 1010b or heating pads 360a and 360b corresponding to a feeding substrate may be arranged in the opaque region 312. The second dielectric substrate 1010b arranged in the opaque region 312 may be referred to as an opaque substrate. Even when the antenna assembly 1000 is arranged in the entire region of the glass panel 310 as illustrated in FIG. 5C, the heating pads 360a and 360b may be arranged in the opaque region 312.

Referring to FIG. 5B, the antenna assembly 1000 may include a first transparent dielectric substrate 1010a and a second dielectric substrate 1010b. Referring to FIGS. 5B and 5C, the antenna assembly 1000 may include an antenna module 1100 configured with conductive patterns, and a second dielectric substrate 1010b. The antenna module 1100 may be provided with a transparent electrode part to be implemented as a transparent antenna module. The antenna module 1100 may include one or more antenna elements. The antenna module 1100 may include a MIMO antenna and/or other antenna elements for wireless communication. The other antenna elements may include at least one of GNSS/radio/broadcasting/Wi-Fi/satellite communication/UWB, and remote keyless entry (RKE) antennas for vehicle applications.

Referring to FIGS. 5A to 5C, the antenna assembly 1000 may be interfaced with the TCU 300 through the connector part 313. The connector part 313 may include a connector 313c on an end of a cable to be electrically connected to the TCU 300. A signal pattern formed on the second dielectric substrate 1010b of the antenna assembly 1000 may be connected to the TCU 300 through the connector part 313 such as a coaxial cable. The antenna module 1100 may be electrically connected to the TCU 300 through the connector part 313. The TCU 300 may be arranged inside the vehicle, but is not limited thereto. The TCU 300 may be arranged on a dashboard inside the vehicle or a ceiling region inside the vehicle, but is not limited thereto.

In some examples, when the transparent antenna assembly according to the disclosure is attached to the inside or surface of the glass panel 310, a transparent electrode part including an antenna pattern and a dummy pattern may be arranged in the transparent region 311. On the other hand, an opaque substrate part may be arranged in the opaque region 312.

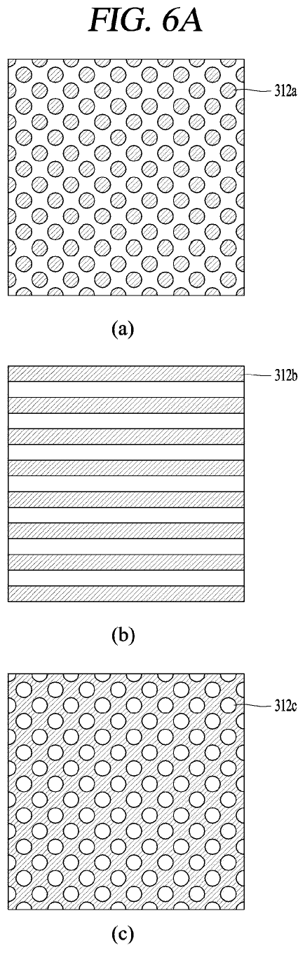

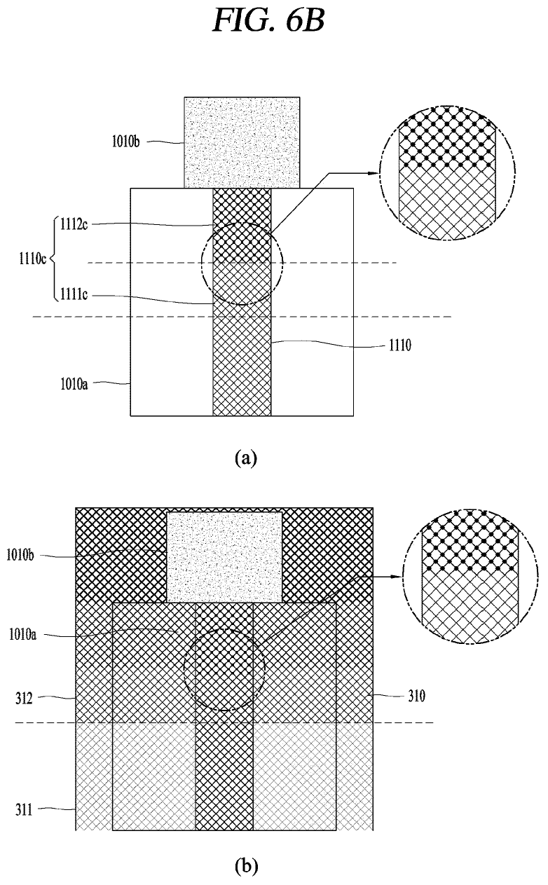

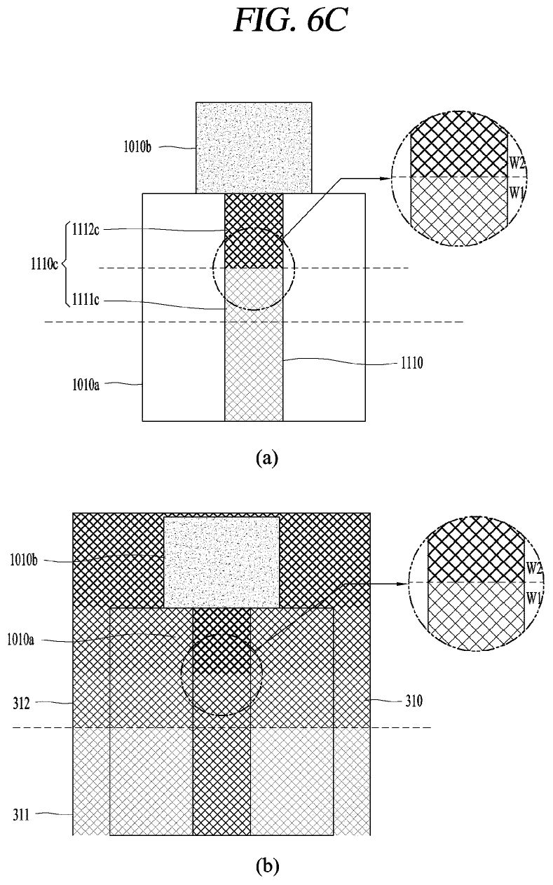

The antenna assembly formed on the vehicle glass according to the disclosure may be arranged in the transparent region and the opaque region. In this regard, FIG. 6A illustrates various embodiments of frit patterns according to the specification. FIGS. 6B and 6C illustrate transparent antenna patterns according to embodiments and structures in which the respective transparent antenna patterns are arranged on vehicle glass.

Referring to (a) of FIG. 6A, a frit pattern 312a may be a metal pattern in a circular (polygonal, or elliptical) shape with a certain diameter. The frit pattern 312a may be arranged in a two-dimensional (2D) structure in both axial directions. The frit pattern 312a may be formed in an offset structure where center points between patterns forming adjacent rows are spaced apart by a certain distance.

Referring to (b) of FIG. 6A, the frit pattern 312b may be formed as a rectangular pattern in one axial direction. The frit pattern 312c may be arranged in a one-dimensional structure in one axial direction or in a 2D structure in both axial directions.

Referring to (c) of FIG. 6A, the frit pattern 312c may be formed as a slot pattern, which is formed by removing a metal pattern in a circular (polygonal or elliptical) shape with a certain diameter. The frit pattern 312b may be arranged in a 2D structure in both axial directions. The frit pattern 312c may be formed in an offset structure where center points between patterns forming adjacent rows are spaced apart by a certain distance.

Referring to FIGS. 5A to 6C, the opaque substrate 1010b and the transparent substrate 1010a may be electrically connected to each other in the opaque region 312. In this regard, a dummy pattern, which is electrically very small to have a certain size or less, may be positioned adjacent to the antenna pattern to secure the invisibility of a transparent antenna pattern. Accordingly, a pattern within a transparent electrode may be made invisible to the naked eye without deterioration of antenna performance. The dummy pattern may be designed to have similar optical transmittance to that of the antenna pattern within a certain range.

The transparent antenna assembly including the opaque substrate 1010b bonded to the transparent electrode part may be mounted on the glass panel 310. In this regard, to ensure invisibility, the opaque substrate 1010b connected to an RF connector or coaxial cable may be arranged in the opaque region 312 of the vehicle glass. Meanwhile, the transparent electrode part may be arranged in the transparent region 311 of the vehicle glass to ensure the invisibility of the antenna from outside of the vehicle glass.

A portion of the transparent electrode part may be attached to the opaque region 312 in some cases. The frit pattern of the opaque region 312 may be gradated from the opaque region 312 to the transparent region 311. The transmission efficiency of a transmission line may be improved while improving the invisibility of the antenna when the optical transmittance of the frit pattern is adjusted to match the optical transmittance of the transparent electrode part within a certain range. Meanwhile, sheet resistance may be reduced while ensuring invisibility by adopting a metal mesh shape similar to the frit pattern. In addition, the risk of disconnection of the transparent electrode layer during manufacturing and assembly may be reduced by increasing the line width of a metal mesh grid in a region connected to the opaque substrate 1010b.

Referring to (a) of FIG. 6A and FIG. 6B, a conductive pattern 1110 of the antenna module may include metal mesh grids with the same line width in the opaque region 312. The conductive pattern 1110 may include a connection pattern 1110c for connecting the transparent substrate 1010a and the opaque substrate 1010b. In the opaque region 312, the connection pattern 1110c and the frit patterns of a certain shape on both side surfaces of the connection pattern 1110c may be arranged at certain distances. The connection pattern 1110c may include a first transmittance section 1111c with a first transmittance and a second transmittance section 1112c with a second transmittance.

The frit patterns 312a formed in the opaque region 312 may include metal grids with a certain diameter arranged in one axial direction and another axial direction. The metal grids of the frit patterns 312a which correspond to the second transmittance section 1112c of the connection pattern 1110c may be arranged at intersections of the metal mesh grids.

Referring to (b) of FIG. 6A and FIG. 6B, the frit patterns 312b formed in the opaque region 312 may include slot grids, each of which has a certain diameter and is formed by removing a metal region, arranged in one axial direction and another axial direction. The slot grids of the frit patterns 312b may be arranged between the metal mesh grids in the connection pattern 1110c. Accordingly, the metal regions of the frit patterns 312b where slot grids are not formed may be arranged at the intersections of the metal mesh grids.

Referring to FIGS. 6A and 6C, the connection pattern 1110c may include metal mesh grids with a first line width W1 in the first transmittance section 1111c adjacent to the transparent region 311. The connection pattern 1110c may be formed with a second line width W2 thicker than the first line width W1 in the second transmittance section 1112c adjacent to the opaque substrate 1010b. In this regard, the first transparency of the first transmittance section 1111c may be set to be higher than the second transparency of the second transmittance section 1112c.

When the transparent antenna assembly is attached to the inside of the vehicle glass as illustrated in FIGS. 5A to 5C, the transparent electrode part may be arranged in the transparent region 311 and the opaque substrate 1010b may be arranged in the opaque region 312. In this regard, the transparent electrode part may be arranged in the opaque region 312 in some cases.

Metal patterns of a low-transmittance pattern electrode part and a high-transmittance pattern electrode part that are located in the opaque region 312 may partially be arranged in a gradation area of the opaque region 312. When the antenna pattern and a transmission line portion of the low-transmission pattern electrode part are configured as a transparent electrode, a decrease in antenna gain may be caused by the deterioration of transmission efficiency due to an increase in sheet resistance. As a way to overcome this loss of gain, the transmittance of the frit pattern 312 where an electrode is located and the transmittance of the transparent electrode may be made equal to each other within a certain range.

Low sheet resistance may be achieved by increasing the line width of the transparent electrode located in a region where the transmittance of the frit pattern 312a, 312b, 312c is low or by adding the same shape as that of the frit pattern 312a, 312b, 312c. Accordingly, invisibility may be secured while solving the problem of deteriorated transmission efficiency. The transmittance and pattern of the opaque region 312 are not limited to the structure of FIG. 6A and may differ depending on a glass manufacturer or vehicle manufacturer. Accordingly, the shape and transparency (line width and separation distance) of the transparent electrode of the transmission line may change in various ways.

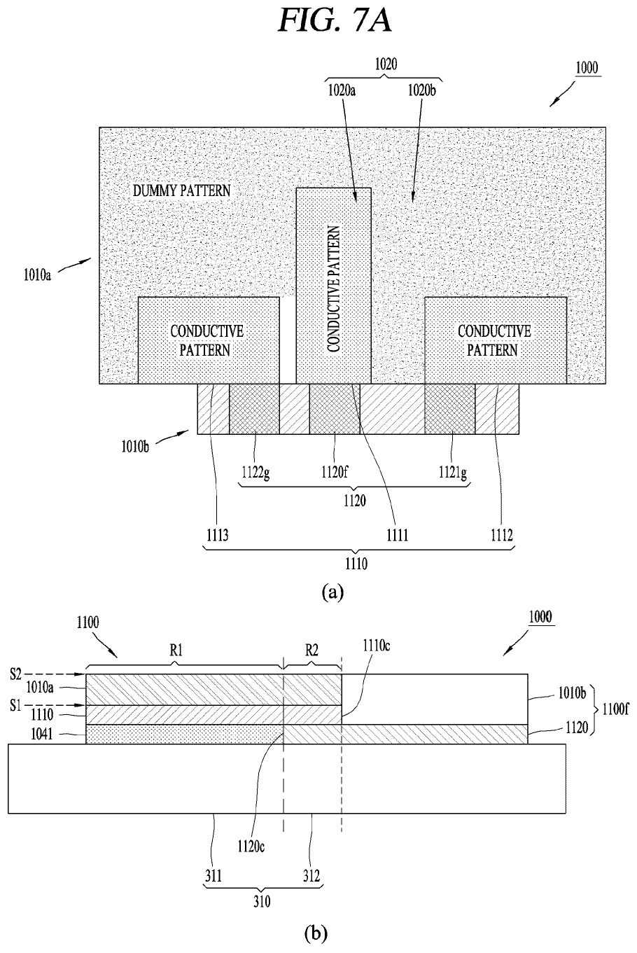

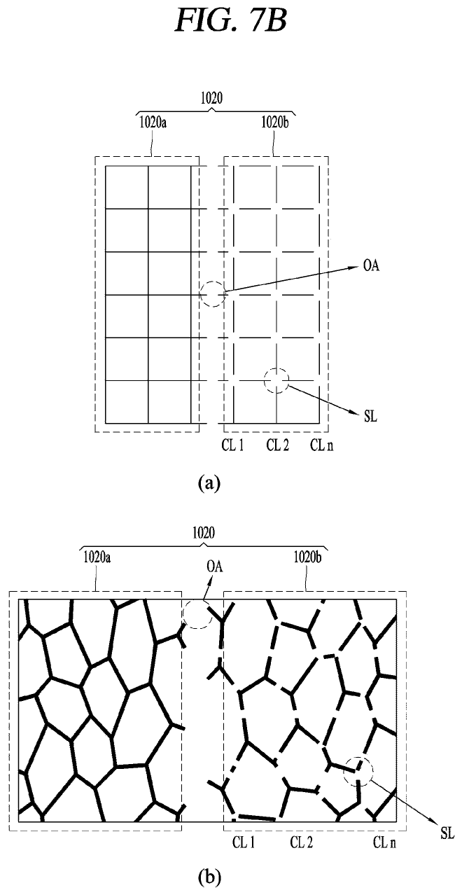

FIG. 7A is a view of a front side and a cross-section of a transparent antenna assembly according to the disclosure. FIG. 7B is a view of a grid structure of a metal mesh radiator region and a dummy metal mesh region according to embodiments.

(a) of FIG. 7A is a front view of a transparent antenna assembly 1000, and (b) of FIG. 7A is a cross-sectional view of the transparent antenna assembly 1000, showing the layered structure of the transparent antenna assembly 1000. Referring to FIG. 7A, the antenna assembly 1000 may include a first transparent dielectric substrate 1010a and a second dielectric substrate 1010b. Conductive patterns 1110 that serves as a radiator may be arranged on one surface of the first transparent dielectric substrate 1010a. A feeding pattern 1120f and ground patterns 1121g and 1122g may be formed on one surface of the second dielectric substrate 1010b. The conductive patterns 1110 operating as the radiator may be configured to include one or more conductive patterns. The conductive patterns 1110 may include a first pattern 1111 connected to the feeding pattern 1120f, and a second pattern 1112 connected to the ground pattern 1121g. The conductive patterns 1110 may further include a third pattern 1113 connected to the ground pattern 1122g.

The conductive patterns 1110 constituting the antenna module may be implemented as a transparent antenna. Referring to FIG. 7B, the conductive patterns 1110 may be metal grid patterns 1020a with a certain line width or less to form a metal mesh radiator region. To maintain a certain level of transparency, dummy metal grid patterns 1020b may be formed in inner regions between adjacent patterns among the first to third patterns 1111, 1112, and 1113 of the conductive patterns 1100 or outer regions of them. The metal grid patterns 1020a and the dummy metal grid patterns 1020b may form a metal mesh layer 1020.

(a) of FIG. 7B illustrates a structure including typical metal grid patterns 1020a and dummy metal grid patterns 1020b. (b) of FIG. 7 illustrates a structure including atypical metal grid patterns 1020a and dummy metal grid patterns 1020b. As illustrated in (a) of FIG. 7B, the metal mesh layer 1020 may be formed in a transparent antenna structure by a plurality of metal mesh grids. The metal mesh layer 1020 may be formed in a typical metal mesh shape, such as a square shape, a diamond shape, or a polygonal shape. Conductive patterns may be configured such that the plurality of metal mesh grids operate as a feeding line or radiator. The metal mesh layer 1020 may constitute a transparent antenna region. As one example, the metal mesh layer 1020 may have a thickness of about 2 mm, but is not limited thereto.

The metal mesh layer 1020 may include the metal grid patterns 1020a and the dummy metal grid patterns 1020b. The metal grid patterns 1020a and the dummy metal grid patterns 1020b may have ends disconnected from each other to form opening areas OA, thereby being electrically disconnected. The dummy metal grid patterns 1020b may have slits SL formed so that ends of mesh grids CL1, CL2, . . . , CLn are not connected.

Referring to (b) of FIG. 7B, the metal mesh layer 1020 may be formed by a plurality of atypical metal mesh grids. The metal mesh layer 1020 may include the metal grid patterns 1020a and the dummy metal grid patterns 1020b. The metal grid patterns 1020a and the dummy metal grid patterns 1020b may have ends disconnected from each other to form the opening areas OA, thereby being electrically disconnected. The dummy metal grid patterns 1020b may have slits SL formed so that ends of mesh grids CL1, CL2, . . . , CLn are not connected.

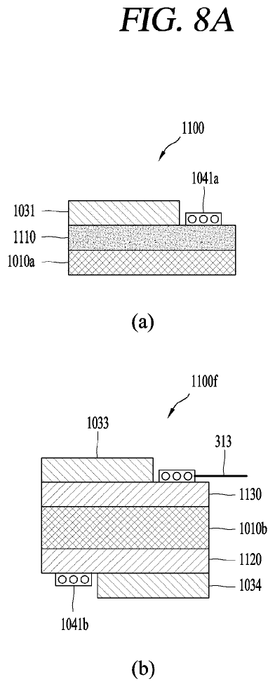

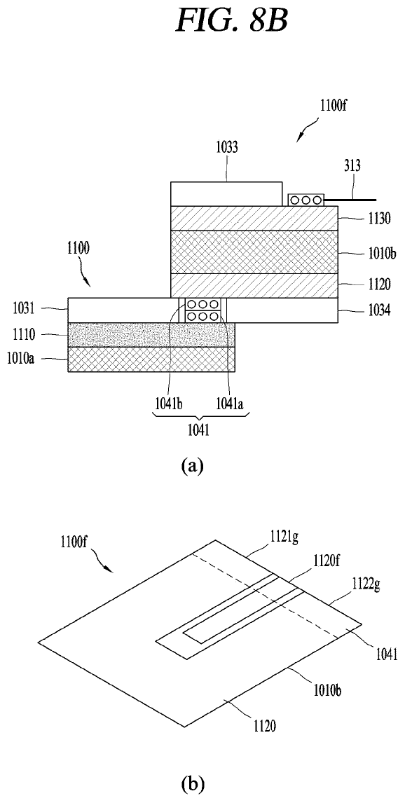

Meanwhile, the transparent substrate on which the transparent antenna according to the specification is formed may be arranged on the vehicle glass. In this regard, FIG. 8A is a view of the layered structure of an antenna module and a feeding pattern. FIG. 8B is a view of an opaque substrate including the layered structure, in which the antenna module and the feeding structure are coupled to each other, and a coupling region.

Referring to (a) of FIG. 8A, the antenna module 1100 may include a first transparent dielectric substrate 1010a formed on a first layer, and a first conductive pattern 1110 formed on a second layer arranged on the first layer. The first conductive pattern 1110 may be implemented as the metal mesh layer 1020 including the metal grid patterns 1020a and the dummy metal grid patterns 1020b, as illustrated in FIG. 7B. The antenna module 1100 may further include a protective layer 1031 and an adhesive layer 1041a arranged on the second layer.

Referring to (b) of FIG. 8A, a feeding structure 1100f may include a second dielectric substrate 1010b, a second conductive pattern 1120, and a third conductive pattern 1130. The feeding structure 1100f may further include first and second protective layers 1033 and 1034 stacked on the second conductive pattern 1120 and the third conductive pattern 1130, respectively. The feeding structure 1100f may further include an adhesive layer 1041b formed on a partial region of the second conductive pattern 1120.

The second conductive pattern 1120 may be arranged on one surface of the second dielectric substrate 1010b implemented as an opaque substrate. The third conductive pattern 1130 may be arranged on another surface of the second dielectric substrate 1010b. The first protective layer 1033 may be formed on the third conductive pattern 1130. The second protective layer 1034 may be formed below the second conductive pattern 1120. Each of the first and second protective layers 1033 and 1034 may be configured to have a low permittivity below a certain value, enabling low-loss feeding to the transparent antenna region.

Referring to (a) of FIG. 8B, the antenna module 1100 may be coupled with the feeding structure 1100f including the second dielectric substrate 1010b, which is the opaque substrate. The first conductive pattern 1110 implemented as the metal mesh layer, which is the transparent electrode layer, may be formed on top of the first transparent dielectric substrate 1010a. The protective layer 1031 may be formed on top of the first conductive pattern 1110. The protective layer 1031 and the first adhesive layer 1041a may be formed on top of the first conductive pattern 1110. The first adhesive layer 1041a may be formed adjacent to the protective layer 1031.

The first adhesive layer 1041a formed on the first conductive pattern 1110 may be bonded to the second adhesive layer 1041b formed below the second conductive layer 1120. The first transparent dielectric substrate 1010a and the second dielectric substrate 1010b may be adhered by the bonding between the first and second adhesive layers 1041a and 1041b. Accordingly, the metal mesh grids formed on the first transparent dielectric substrate 1010a may be electrically connected to the feeding pattern formed on the second dielectric substrate 1010b.

The second conductive pattern 1120 and the third conductive pattern 1130 may be arranged on one surface and another surface of the second dielectric substrate 1010b, thereby implementing the feeding structure 1100f. The feeding structure 1100f may be implemented as a flexible printed circuit board (FPCB), but is not limited thereto. The first protective layer 1033 may be arranged on the third conductive pattern 1130, and the second protective layer 1034 may be arranged below the second conductive pattern 1120. The adhesive layer 1041b below the third conductive pattern 1130 may be bonded to the adhesive layer 1041a of the antenna module 1100. Accordingly, the feeding structure 1100f may be coupled with the antenna module 1100 and the first and second conductive patterns 1110 and 1120 may be electrically connected.

The antenna module 1100 implemented with the first transparent dielectric substrate 1010a may be formed to have a first thickness. The feeding structure 1100f implemented with the second dielectric substrate 1010b may be formed to have a second thickness. For example, the thicknesses of the dielectric substrate 1010a, the first conductive pattern 1110, and the protective layer 1031 of the antenna module 1100 may be 75 μm, 9 μm, and 25 μm, respectively. The first thickness of the antenna module 1100 may be 109 μm. The thicknesses of the second dielectric substrate 1010b, the second conductive pattern 1120, and the third conductive pattern 1130 of the feeding structure 1100f may be 50 μm, 18 μm, and 18 μm, respectively, and the thicknesses of the first and second protective layers 1033 and 1034 may be 28 μm. Accordingly, the second thickness of the feeding structure 1100f may be 142 μm. Since the adhesive layers 1041a and 1041b are formed on the first conductive pattern 1110 and below the second conductive pattern 1120, the entire thickness of the antenna assembly may be smaller than the sum of the first thickness and the second thickness. For example, the antenna assembly 1000 including the antenna module 1100 and the feeding structure 1100f may have a thickness of 198 μm.

Referring to (b) of FIG. 8B, the conductive pattern 1120 may be formed on one surface of the second dielectric substrate 1010b forming the feeding structure 1100f. The conductive pattern 1120 may be formed in a CPW-type feeding structure that includes the feeding pattern 1120f and the ground patterns 1121g and 1122g formed on both sides of the feeding pattern 1120f. The feeding structure 1100f may be coupled with the antenna module 1100, as illustrated in (a) of FIG. 8B, through a region where the adhesive layer 1041 is formed.

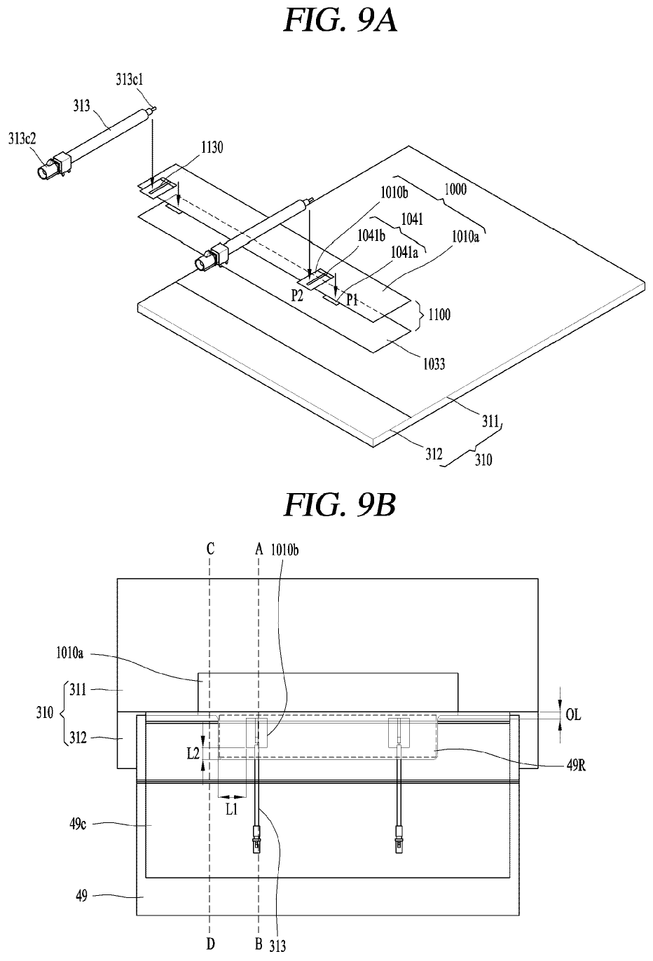

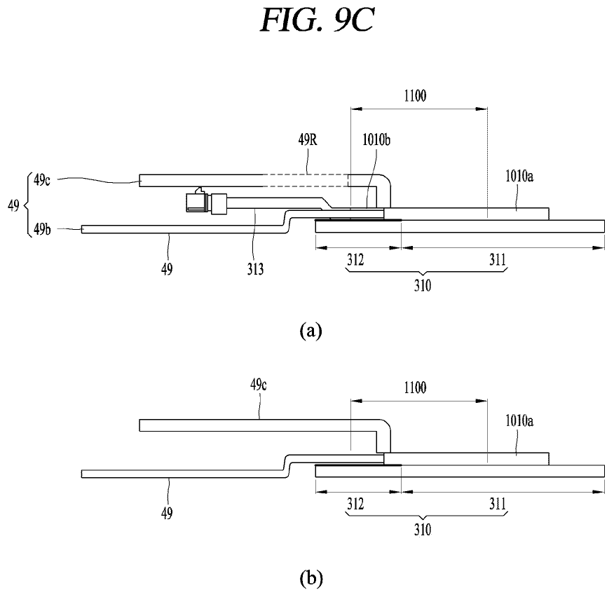

The antenna module and the feeding structure constituting the antenna assembly according to the specification may be arranged on the vehicle glass and coupled through a specific coupling structure. In this regard, FIG. 9A illustrates a coupling structure of a transparent antenna that is arranged in a transparent region and a frit region of a vehicle glass.

Referring to FIG. 9A, the first transparent dielectric substrate 1010a may be adhered to the glass panel 310 through the adhesive layer 1041. The conductive pattern of the first transparent dielectric substrate 1010a may be bonded to the conductive pattern 1130 of the second dielectric substrate 1010b through ACF bonding. ACF bonding involves bonding of a tape, to which metal balls are added, to a bonding surface at high temperature/high pressure (e.g., 120 to 150 degrees, 2 to 5 Mpa) for a few seconds, and may be achieved by allowing electrodes to be in contact with each other through the metal balls therebetween. ACF bonding may electrically connect conductive patterns and simultaneously provide adhesive strength by thermally hardening the adhesive layer 1041.

The first transparent dielectric substrate 1010a, on which the transparent electrode layer is formed, and the second dielectric substrate 1010b in the form of FPCB may be attached to each other through local soldering. The connection pattern of the FPCB and the transparent antenna electrode may be connected through the local soldering using a coil in a magnetic field induction manner. During such local soldering, an increase in temperature of a soldered portion may not occur or the FPCB may be maintained flat without deformation. Accordingly, an electrical connection with high reliability may be achieved through the local soldering between the conductive patterns of the first transparent dielectric substrate 1010a and the second dielectric substrate 1010b.

The first transparent dielectric substrate 1010a, the metal mesh layer 1020 of FIG. 7A, the protective layer 1033, and the adhesive layer 1041 may form a transparent electrode. The second dielectric substrate 1010b, which is the opaque substrate, may be implemented as the FPCB, but is not limited thereto. The second dielectric substrate 1010b, which is the FPCB with the feeding pattern, may be connected to the connector part 313 and the transparent electrode.

The second dielectric substrate 1010b, which is the opaque substrate, may be attached to a partial region of the first transparent dielectric substrate 1010a. The first transparent dielectric substrate 1010a may be formed in the transparent region 311 of the glass panel 310. The second dielectric substrate 1010b may be formed in the opaque region 312 of the glass panel 310. The partial region of the first transparent dielectric substrate 1010a may be formed in the opaque region 312, and the first transparent dielectric substrate 1010a may be coupled to the second dielectric substrate 1010b in the opaque region 312.

The first transparent dielectric substrate 1010a and the second dielectric substrate 1010b may be adhered by the bonding between the adhesive layers 1041a and 1041b. A position at which the second dielectric substrate 1010b is bonded to the adhesive layer 1041 may be set to a first position P1. A position at which the connector part 313 is soldered to the opaque substrate 1010b may be set to a second position P2.

Meanwhile, the vehicle glass on which the antenna assembly according to the specification is formed may be coupled to a body structure of the vehicle. In this regard, FIG. 9B is an enlarged front view of a region where glass with the transparent antenna of FIG. 9A is coupled to a body structure of a vehicle. FIG. 9C is a cross-sectional view of the coupling structure between the vehicle glass and the body structure of FIG. 9B, viewed from different positions.

Referring to FIG. 9B, the first transparent dielectric substrate 1010a on which a transparent antenna is formed may be arranged in the transparent region 311 of the glass panel 310. The second dielectric substrate 1010b may be arranged in the opaque region 312 of the glass panel 310. Since the transmittance of the opaque region 312 is lower than that of the transparent region 311, the opaque region 312 may also be referred to as a black matrix (BM) region. A portion of the first transparent dielectric substrate 1010a on which the transparent antenna is formed may extend up to the opaque region 312 corresponding to the BM region. The first transparent dielectric substrate 1010a and the opaque region 312 may be formed to overlap each other by an overlap length OL in one axial direction.

(a) of FIG. 9C is a cross-sectional view of the antenna assembly, cut along the line AB in FIG. 9B. (a) of FIG. 9C is a cross-sectional view of the antenna assembly, cut along the line CD in FIG. 9B.

Referring to FIG. 9B and (a) of FIG. 9C, the first transparent dielectric substrate 1010a on which the transparent antenna is formed may be arranged in the transparent region 311 of the glass panel 310. The second dielectric substrate 1010b may be arranged in the opaque region 312 of the glass panel 310. The partial region of the first transparent dielectric substrate 1010a may extend up to the opaque region 312, so that the feeding pattern formed on the second dielectric substrate 1010b and the metal mesh layer of the transparent antenna are bonded and connected to each other.

An interior cover 49c may be configured to accommodate the connector part 313 connected to the second dielectric substrate 1010b. The connector part 313 may be arranged in a space between a body 49b made of a metal material and the interior cover 49c, and the connector part 313 may be coupled to an in-vehicle cable. The interior cover 49c may be arranged in an upper region of the body 49b made of the metal material. The interior cover 49c may be formed with one end bent to be coupled to the metal body 49b.

The interior cover 49c may include a metal material or dielectric material. When the interior cover 49c is made of a metal material, the interior cover 49c and the body 49b made of the metal material may constitute a metal frame 49. In this regard, the vehicle may include the metal frame 49. The opaque region 312 of the glass panel 310 may be supported by a portion of the metal frame 49. To this end, a portion of the body 49b of the metal frame 49 may be bent to be coupled to the opaque region 312 of the glass panel 310.

When the interior cover 49c is made of a metal material, at least a portion of a metal region of the interior cover 49c in the upper region of the second dielectric substrate 1010b may be cut out. A recess portion 49R from which the metal region has been cut out may be formed in the interior cover 49c. Accordingly, the metal frame 49 may include the recess portion 49R. The second dielectric substrate 1010b may be placed within the recess portion 49R of the metal frame 49.

The recess portion 49R may also be referred to as a metal cut region. One side of the recess portion 49R may be formed to be spaced apart from one side of the opaque substrate 1010b by a first length L1 which is equal to or greater than a threshold value. A lower boundary side of the recess portion 49R may be formed to be spaced apart from a lower boundary side of the opaque substrate 1010b by a second length L2 which is equal to or greater than a threshold value. As the metal is removed from the partial region of the interior cover 49c made of the metal material, signal loss and changes in antenna characteristics due to a surrounding metal structure may be suppressed.

Referring to FIG. 9B and (b) of FIG. 9C, a recess portion like a metal cut region may not be formed in the interior cover 49c in a region where the connector part and the opaque substrate are not arranged. In this regard, while protecting the internal components of the antenna module 1100 by use of the interior cover 49c, internal heat may be dissipated to the outside through the recess portion 49R of FIG. 9B and (a) of FIG. 9C. In addition, whether it is necessary to repair a connected portion may be immediately determined through the recess portion 49R of the interior cover 49c. Meanwhile, since the recess portion is not formed in the interior cover 49c in a region where the connector part and the second dielectric substrate are not arranged, the internal components of the antenna module 1100 may be protected.

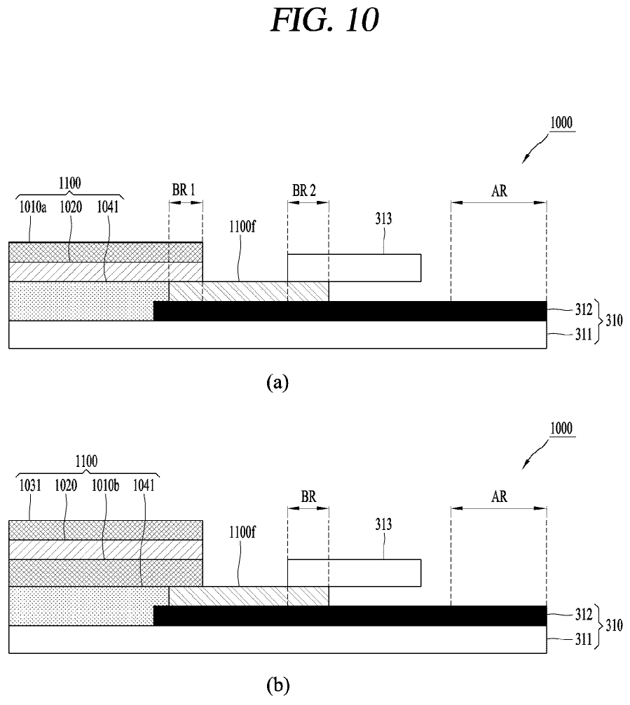

Meanwhile, an antenna assembly 1000 according to the specification may be formed in various shapes on a glass panel 310, and the glass panel 310 may be attached to a vehicle frame. In this regard, FIG. 10 illustrates a stacked structure of an antenna assembly and an attachment region between vehicle glass and a vehicle frame according to embodiments.

Referring to (a) of FIG. 10, the glass panel 310 may include a transparent region 311 and an opaque region 312. The antenna assembly 1000 may include an antenna module 1100 and a feeding structure 1100f. The antenna module 1100 may include a first transparent dielectric substrate 1010a, a transparent electrode layer 1020, and an adhesive layer 1041. The feeding structure 1100f implemented as the opaque substrate and the transparent electrode layer 1020 implemented as the transparent substrate may be electrically connected to each other. The feeding structure 1100f and the transparent electrode layer 1020 may be directly connected through a first bonding region BR1. The feeding structure 1100f and the connector part 313 may be directly connected through a second bonding region BR2. Heat may be applied for bonding in the first and second bonding regions BR1 and BR2. Accordingly, the bonding regions BR1 and BR2 may be referred to as heating sections. An attachment region AR corresponding to a sealant region for attachment of the glass panel 310 to the vehicle frame may be formed on a side end area in the opaque region 312 of the glass panel 310.

Referring to (b) of FIG. 10, the glass panel 310 may include a transparent region 311 and an opaque region 312. The antenna assembly 1000 may include an antenna module 1100 and a feeding structure 1100f. The antenna module 1100 may include a protective layer 1031, the transparent electrode layer 1020, a first transparent dielectric substrate 1010a, and an adhesive layer 1041. The feeding structure 1100f implemented as an opaque substrate may overlap a partial region of the antenna module 1100 implemented as a transparent substrate. The feeding structure 1100f and the transparent electrode layer 1020 of the antenna module 1100 may be connected in a coupled-feeding manner. The feeding structure 1100f and the connector part 313 may be directly connected through a bonding region BR. Heat may be applied for bonding in the bonding region BR1. Accordingly, the bonding region BR may be referred to as a heating section. An attachment region AR corresponding to a sealant region for attachment of the glass panel 310 to the vehicle frame may be formed on a side end area in the opaque region 312 of the glass panel 310.

Referring to (a) and (b) of FIG. 10, the transparent substrate 1010a may include a (hard) coating layer to protect the transparent electrode layer 1020 from an external environment. Meanwhile, a UV-cut component may be added to the adhesive layer 1041 to suppress yellowing due to sunlight.

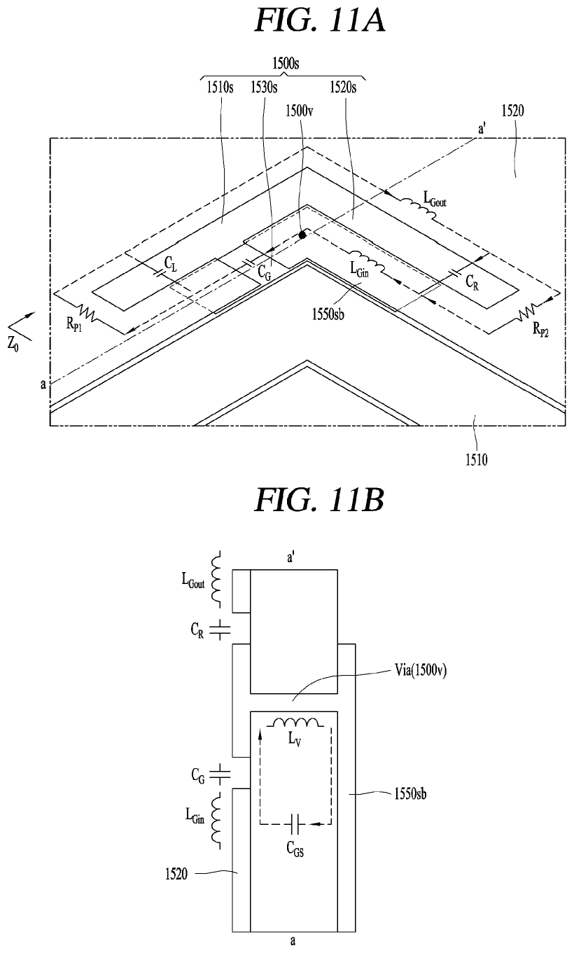

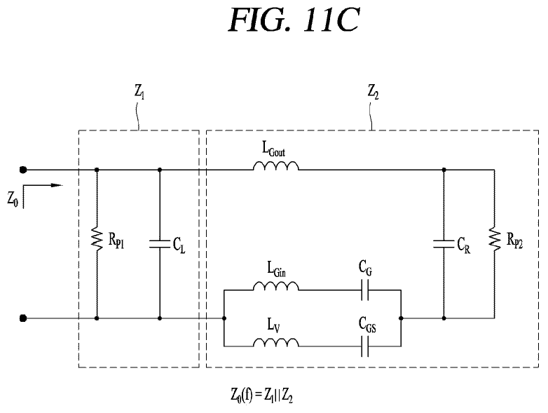

Hereinafter, a vehicle having an antenna assembly that may be attachable to vehicle glass according to this specification will be described with reference to drawings. In this regard, FIG. 11A is a view of an RF choke structure implemented as a slot pattern arranged adjacent to a boundary on one side of a conductive pattern constituting an antenna assembly. FIG. 11B is a cross-sectional view of a dielectric substrate formed along line a-a′ of FIG. 11A. FIG. 11C is a view of an equivalent circuit of the RF choke of FIG. 11A.

Referring to FIGS. 11A and 11B, a first conductive pattern 1510 and a second conductive pattern 1520 may be arranged on one surface of a dielectric substrate. The first conductive pattern 1510 may be formed on the dielectric substrate to have a first length in a first axial direction and a second length in a second axial direction. The second conductive pattern 1520 may be spaced apart from an outer boundary of the first conductive pattern 1510 by a gap region. A slot pattern 1500s may be arranged parallel to the outer boundary of the first conductive pattern 1510 or an inner boundary of the first conductive pattern 1510 and configured to reflect a signal of a specific frequency band.

The slot pattern 1500s may include a first slot pattern 1510s and a second slot pattern 1520s. The slot pattern 1500s may further include a third slot pattern 1530s. The first slot pattern 1510s may be formed with a first slot length in the first axial direction, so that the signal of the specific frequency band may be reflected in an opposite direction on the first axis. The second slot pattern 1520s may be connected to the first slot pattern 1510s. The second slot pattern 1520s may be formed with a second slot length in the second axial direction. The third slot pattern 1530s may be formed to connect a point on an inner side of the first slot pattern 1510s or the second slot pattern 1520s and the gap region on the outside of the first conductive pattern 1510.

An RF choke implemented as the slot pattern 1500s may be arranged in a bending region of the conductive pattern. The reason why the RF choke is arranged in the bending region is to enable a two-dimensional RF choke design and to implement an RF choke structure, which may be used in a ground region, in a single-layer structure through a coplanar waveguide (CPW) structure.

To this end, this specification proposes an RF choke structure implemented as a two-dimensional slot pattern in a bending region of a CPW feeding structure, which is implemented on the same plane as a feeding FPCB of a 4G/5G transparent antenna. Therefore, a candidate region for arranging the RF choke in the feeding FPCB of the transparent antenna may be set, and an optimal RF choke location which may improve isolation may be selected by considering a current flow.

Referring to FIGS. 11A to 11C, an equivalent circuit model of an RF choke, which includes a first conductive pattern 1510, a second conductive pattern 1520, and a slot pattern 1500s, may be expressed by the following parameters. Here, Rₚ₁ denotes an equivalent resistance from a first port to an RF choke, and C_{L} denotes a capacitance between inner and outer sides of the first slot pattern 1510s. C_{R} denotes a capacitance between inner and outer sides of the second slot pattern 1520s, and C_{g} denotes a capacitance of the third slot pattern 1530s formed on the inner side of the first slot pattern 1510s. L_{Gout} denotes an inductance induced between an outer side of the slot pattern 1500 and a ground pattern, and L_{Gin} denotes an inductance induced between an inner side of the slot pattern 1500 and the ground pattern.

In some embodiments, the ground pattern may be implemented as the second conductive pattern 1520. Rₚ₂ denotes an equivalent resistance from the RF choke to a second port, and C_{GS} denotes a capacitance between the ground pattern on one surface of the dielectric substrate and a metal stub 1550sb on another surface. Lᵥ denotes an inductance induced between the ground pattern on the one surface of the dielectric substrate and the metal stub 1550sb on the other surface. The inductance L_{Gout} by an outer length of the slot pattern 1500s, the capacitances C_{L} and C_{R} by a width between the inner and outer sides of the slot pattern 1500s, and the capacitance C_{Gs} by the metal stub 1150sb may determine an input impedance Z₀(f). The inductance and capacitances may be main parameters affecting the change in the input impedance Z₀(f) and a resonant frequency f.

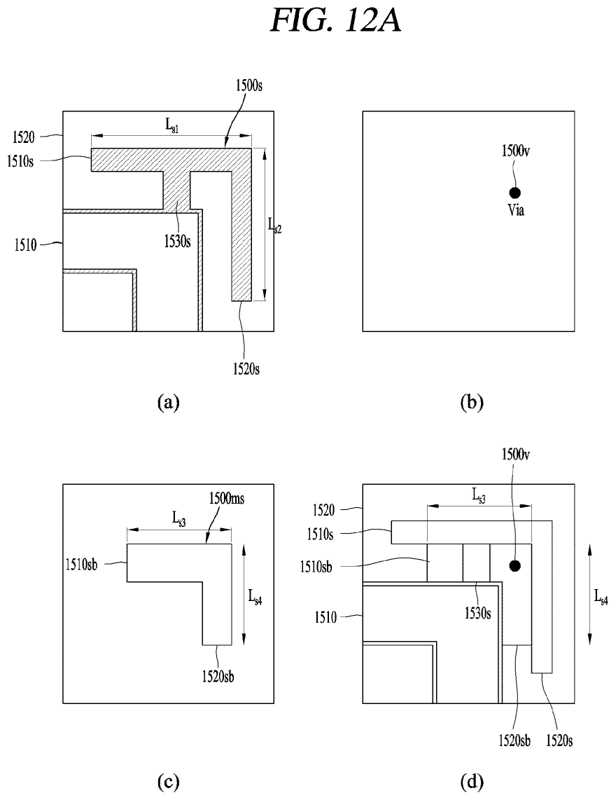

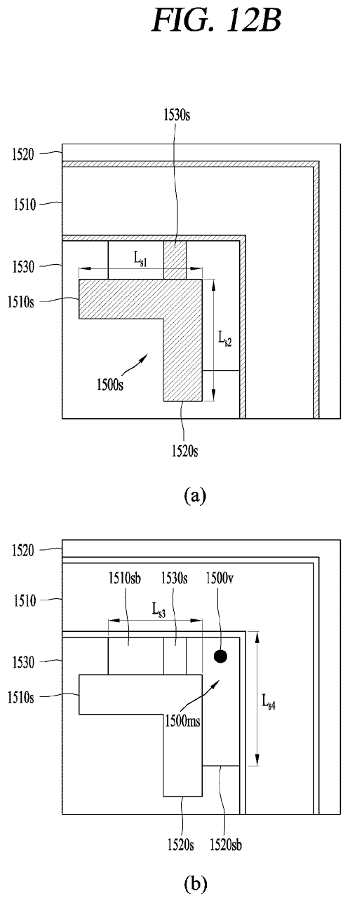

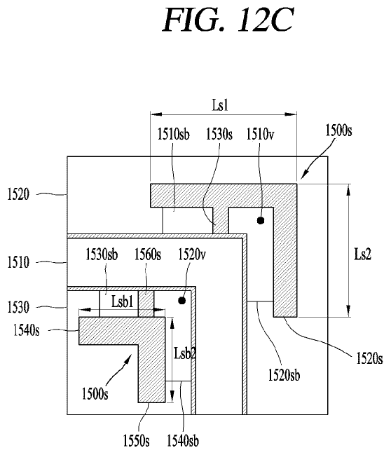

Hereinafter, a layer structure of an RF choke implemented in an antenna assembly which may be attachable to vehicle glass according to the specification will be described in detail with reference to the drawings. FIG. 12A is a view of a layer structure of an RF choke formed in an outer region of a conductive pattern. (a) to (c) of FIG. 12A show a front region, an inner region, and a rear region of a dielectric substrate. (d) of FIG. 12A shows an overlapped state of the front, inner, and rear regions of the dielectric substrate on which the RF choke connected through a via hole is implemented.

Referring to (a) of FIG. 12A, the second conductive pattern 1520 may be spaced apart from an outer boundary of the first conductive pattern 1510 by a gap region. The slot pattern 1500s may be arranged in an outer region of the first conductive pattern 1510 to be parallel to the outer boundary of the first conductive pattern 1510 and configured to reflect a signal of a specific frequency band.

The slot pattern 1500s may include a first slot pattern 1510s to a third slot pattern 1530s. The first slot pattern 1510s may be formed with a first slot length Ls1 in a first axial direction, so that the signal of the specific frequency band may be reflected in an opposite direction on the first axis. The second slot pattern 1520s may be connected to the first slot pattern 1510s. The second slot pattern 1520s may be formed with a second slot length Ls2 in a second axial direction. The first slot length Ls1 and the second slot length Ls2 may be set to the same length Δin or to different lengths by a certain length difference δ2-δ1. The third slot pattern 1530s may be formed to connect a point on an inner side of the first slot pattern 1510s or the second slot pattern 1520s and the gap region on the outside of the first conductive pattern 1510. The gap region on the outside of the first conductive pattern 1510 may be formed as a slog region.

Referring to (b) of FIG. 12B, a via hole 1500v which vertically connects conductive patterns on front and rear surfaces of the dielectric substrate may also be formed in the inner region of the dielectric substrate. In this regard, the inside of the via hole 1500v may be filled with a conductor or a side region of the via hole 1500v may be coated with a conductor while an inside is hollow.

Referring to (c) of FIG. 12A, the metal stub 1500 ms may be formed on the rear surface of the dielectric substrate. The metal stub 1500 ms may include a third sub-pattern 1510sb and a fourth sub-pattern 1520sb. The third sub-pattern 1510sb may be arranged on the rear surface of the dielectric substrate and connected to the via hole 1500v. The via hole 1500v may be arranged in a region where the third sub-pattern 1510sb and the fourth sub-pattern 1520sb overlap each other. The third sub-pattern 1510sb may be formed with a third length Ls3 in the first axial direction. The fourth sub-region 1520sb may be connected to the third sub-region 1510sb. The fourth sub-pattern 1520sb may be formed with a fourth length Ls4 in the second axial direction. The third length Ls3 and the fourth length Ls4 may be set to the same length Mout or to different lengths by a certain length difference ε2-ε1.

Referring to (a) to (d) of FIG. 12A, the via hole 1500v may be formed to vertically connect the second conductive pattern 1520 formed on an outer boundary of the first conductive pattern 1510 on the front surface of the dielectric substrate and the metal stub 1500 ms on the rear surface of the dielectric substrate. The via hole 1500v may be arranged in a region where the third sub-pattern 1510sb and the fourth sub-pattern 1520sb of the metal stub 1500 ms overlap each other. The via hole 1500v may be arranged in a lower region of the first slot pattern 1510s. The via hole 1500v may be arranged in one side region of the second slot pattern 1520s.

In some embodiments, FIG. 12B is a view of a layer structure of an RF choke formed in an inner region of the conductive pattern. (a) of FIG. 12B shows a structure with an RF choke implemented in the inner region of the conductive pattern. (a) of FIG. 12B shows a structure with an RF choke of structure in which the front and rear surfaces of the dielectric substrate are connected by the via hole.

Referring to (a) of FIG. 12B, the second conductive pattern 1520 may be spaced apart from an outer boundary of the first conductive pattern 1510 by a gap region. The third conductive pattern 1530 may be spaced apart from the outer boundary of the first conductive pattern 1510 by a gap region. The slot pattern 1500s may be arranged in the inner region to be parallel to the inner boundary of the first conductive pattern 1510 and configured to reflect a signal of a specific frequency band.

The slot pattern 1500s may include a first slot pattern 1510s to a third slot pattern 1530s. The first slot pattern 1510s may be formed with a first slot length Ls1 in the first axial direction, so that the signal of the specific frequency band may be reflected in an opposite direction on the first axis. The second slot pattern 1520s may be connected to the first slot pattern 1510s. The second slot pattern 1520s may be formed with a second slot length Ls2 in the second axial direction. The first slot length Ls1 and the second slot length Ls2 may be set to the same length Δin or to different lengths by a certain length difference δ2-δ1. The third slot pattern 1530s may be formed to connect a point on the inner side of the first slot pattern 1510s or the second slot pattern 1520s and the gap region on the outside of the first conductive pattern 1510. The gap region on the outside of the first conductive pattern 1510 may be formed as a slog region.

Referring to (b) of FIG. 12B, a via hole 1500v which vertically connects conductive patterns on front and rear surfaces of the dielectric substrate may also be formed in the inner region of the dielectric substrate. In this regard, the inside of the via hole 1500v may be filled with a conductor or a side region of the via hole 1500v may be coated with a conductor while its inside is hollow. The metal stub 1500 ms may be formed on the rear surface of the dielectric substrate. The metal stub 1500 ms may include a third sub-pattern 1510sb and a fourth sub-pattern 1520sb. The third sub-pattern 1510sb may be arranged on the rear surface of the dielectric substrate and connected to the via hole 1500v. The via hole 1500v may be arranged in a region where the third sub-pattern 1510sb and the fourth sub-pattern 1520sb overlap each other. The third sub-pattern 1510sb may be formed with a third length Ls3 in the first axial direction. The fourth sub-region 1520sb may be connected to the third sub-region 1510sb. The fourth sub-pattern 1520sb may be formed with a fourth length Ls4 in the second axial direction. The third length Ls3 and the fourth length Ls4 may be set to the same length Mout or to different lengths by a certain length difference ε2-ε1.

Referring to (a) and (b) of FIG. 12B, the via hole 1500v may be formed to vertically connect the third conductive pattern 1530 formed on the inner boundary of the first conductive pattern 1510 on the front surface of the dielectric substrate and the metal stub 1500 ms on the rear surface of the dielectric substrate. The via hole 1500v may be arranged in a region where the third sub-pattern 1510sb and the fourth sub-pattern 1520sb of the metal stub 1500 ms overlap each other. The via hole 1500v may be arranged in an upper region of the first slot pattern 1510s. The via hole 1500v may be arranged in another side region of the second slot pattern 1520s.

An RF choke according to another embodiment may be implemented in both the outer region and the inner region of the first conductive pattern. FIG. 12C is a view of an RF choke structure implemented in both outer and inner regions of a first conductive pattern. Referring to FIG. 12C, a first RF choke implemented as an outer-form and a second RF choke implemented as an inner-form may be arranged in both the outer and inner regions of the first conductive pattern 1510. The slot pattern 1500 may include a first slot pattern 1510s to a third slot pattern 1530s formed in the outer region of the first conductive pattern 1510. The slot pattern 1500 may include a fourth slot pattern 1540s to a sixth slot pattern 1560s formed in the inner region of the first conductive pattern 1510.

The first slot pattern 1510s may be formed with a first slot length Ls1 in the first axial direction. The second slot pattern 1520s may be connected to the first slot pattern 1510s and formed with a second slot length Ls2 in the second axial direction. The third slot pattern 1530s may be formed to connect a point on the inner boundary of the first slot pattern 1510s and the gap region on the outer side of the first conductive pattern 1510. A first via hole 1510v may be formed to vertically connect a region of the second conductive pattern 1520 formed below the first slot pattern 1510s and a region where metal stubs 1510sb and 1520sb are connected.

The fourth slot pattern 1540s may be formed with a fourth slot length Ls1b in the first axial direction. The fifth slot pattern 1550s may be connected to the fourth slot pattern 1540s and formed with a fifth slot length Lsb2 in the second axial direction. The third slot pattern 1530s may be formed to connect a point on the outer boundary of the fourth slot pattern 1540s and the gap region on the inner side of the first conductive pattern 1510. A second via hole 1520v may be formed to vertically connect a region of the third conductive pattern 1530 formed above the fourth slot pattern 1540s and a region where metal stubs 1530sb and 1540sb are connected.

The first and second slot lengths Ls1 and Ls2 of the RF choke may be smaller than ¼ of a first wavelength λ1 corresponding to a first target frequency of a Wi-Fi band. The third and fourth lengths Ls3 and Ls4 of the metal stub 1500 ms operating as an equivalent capacitor of the RF choke may be smaller than the first and second slot lengths Ls1 and Ls2, respectively. Accordingly, the relationships Ls3<Ls1 and Ls4<Ls2 may be established. In some embodiments, the first and second slot lengths Ls1 and Ls2 may be adjusted by adjustment values 81 and 82 by considering the lowest and highest values of the Wi-Fi target frequency. The third and fourth lengths Ls3 and Ls4 of the metal stub 1500 ms may be adjusted by adjustment values ε1 and ε2 by considering the lowest and highest values of the Wi-Fi target frequency.

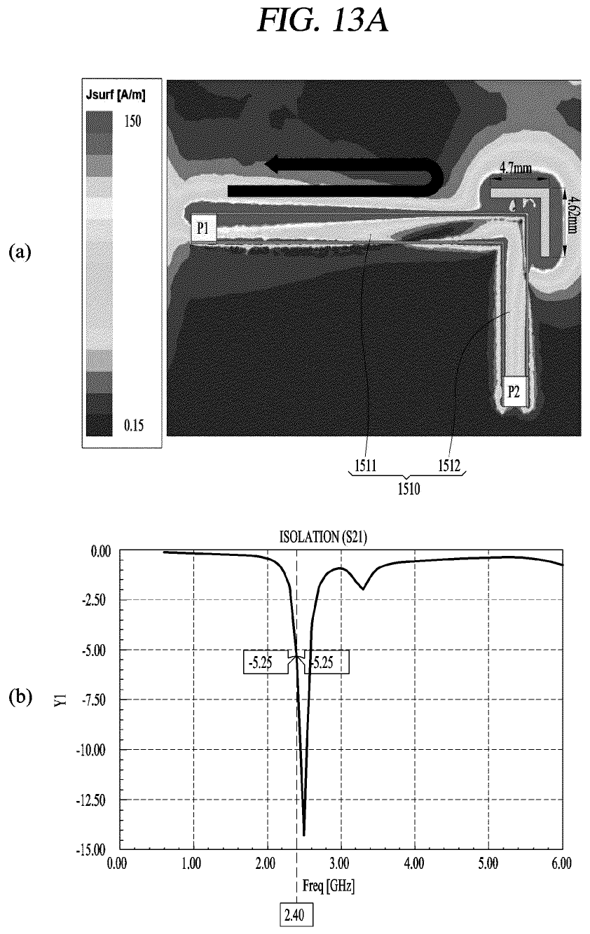

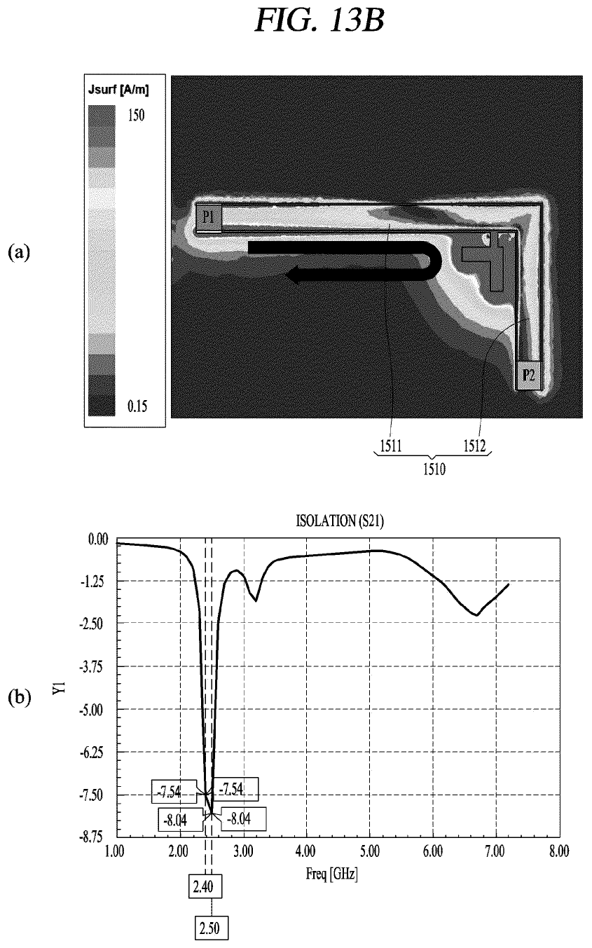

As described above, the RF choke configured as the slot pattern according to the specification may be arranged in the outer region or the inner region of the first conductive pattern. In this regard, FIG. 13A is a view of current distribution and isolation characteristics of the RF choke structure arranged in the outer region of the first conductive pattern. FIG. 13B is a view of current distribution and isolation characteristics of the RF choke structure arranged in the inner region of the first conductive pattern.

Referring to FIG. 12A and (a) of FIG. 13A, a signal applied from a first port P1, which is one end portion of a first sub-pattern 1511 of the first conductive pattern 1510, may be reflected from the first slot pattern 1510s. The lengths of the first and second slot patterns 1510s and 1520s may be about a ¼ wavelength, and thus a remaining signal which is transmitted without being reflected from the first slot pattern 1510s may also be reflected from another end portion of the second slot pattern 1520s. Accordingly, a current distribution in the slot pattern 1500s including the first and second slot patterns 1510s and 1520s and a region adjacent to the slot pattern 1500s may be higher than a current distribution in other regions.

Referring to FIG. 12A and (b) of FIG. 13A, a signal transmitted to a second port P2, which is another end portion of a second sub-pattern 1512 of the first conductive pattern 1510, may be below a threshold level in the Wi-Fi frequency band. An isolation characteristic value between the first and second ports P1 and P2 may be −5.2 dB or less in a frequency band of 2.4-2.5 GHz due to the RF choke. In this regard, the first slot length Ls1 of the first slot pattern 1510s may be formed in a certain range based on 4.7 mm. The second slot length Ls2 of the second slot pattern 1520s may be formed in a certain range based on 4.62 mm.

Referring to FIG. 12B and (b) of FIG. 13B, a signal applied from a first port P1, which is one end portion of a first sub-pattern 1511 of the first conductive pattern 1510, may be reflected from the first slot pattern 1510s. The lengths of the first and second slot patterns 1510s and 1520s may be about a ¼ wavelength, and thus a remaining signal which is transmitted without being reflected from the first slot pattern 1510s may also be reflected from another end portion of the second slot pattern 1520s. Accordingly, a current distribution in the slot pattern 1500s including the first and second slot patterns 1510s and 1520s and a region adjacent to the slot pattern 1500s may be higher than a current distribution in other regions.

Referring to FIG. 12A to (b) of FIG. 13A, a signal transmitted to a second port P2, which is another end portion of a second sub-pattern 1512 of the first conductive pattern 1510, may be below a threshold level in the Wi-Fi frequency band. An isolation characteristic value between the first and second ports P1 and P2 may be −7.5 dB or less in a frequency band of 2.4 to 2.5 GHz due to the RF choke. In this regard, the first slot length Ls1 of the first slot pattern 1510s may be formed in a certain range based on 3.2 mm. The second slot length Ls2 of the second slot pattern 1520s may be formed in a certain range based on 3.12 mm.

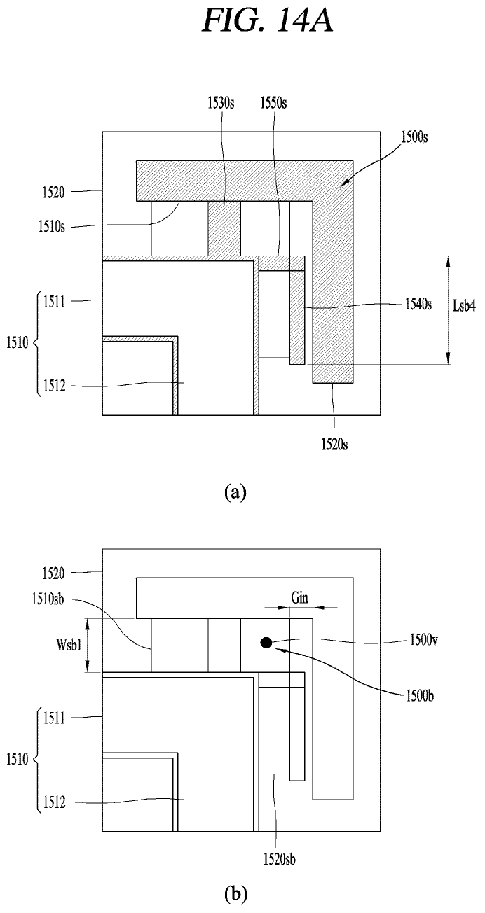

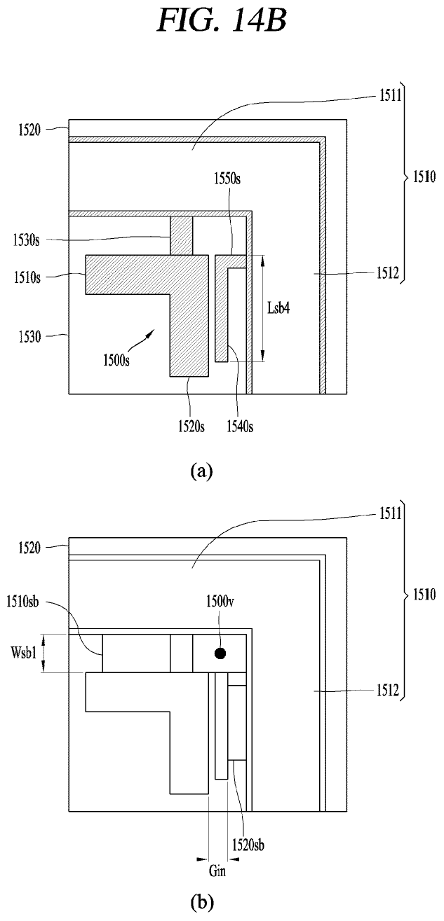

In some embodiments, an RF choke configured as a slot pattern according to the specification may include a slot pattern 1500s configured to block signals of a first frequency band of 2.4 to 2.5 GHz and a second frequency band of 5.15 to 5.85 GHz. In this regard, FIGS. 14A and 14B are views of arrangements of RF chokes which are arranged in the outer region and the inner region of the first conductive pattern and operate in a dual band. (a) and (b) of FIG. 14A show a slot pattern structure formed in the outer region of the first conductive pattern and a structure in which a via hole is connected. (a) and (b) of FIG. 14B show a slot pattern structure formed in the inner region of the first conductive pattern and a structure in which a via hole is connected.

Referring to FIGS. 14A and 14B, the slot pattern 1500s of the RF choke according to the specification may be configured to block signals of different frequency bands through additional slot patterns. The slot pattern 1500s may be configured to block signals of a first frequency band of 2.4 to 2.5 GHz and a second frequency band of 5.15 to 5.85 GHz. The slot pattern 1500s may be configured to further include first to third slot patterns 1510s to 1530s, a fourth slot pattern 1540s, and a fifth slot pattern 1550s. The third slot pattern 1530s may be formed to connect a point of the first slot pattern 1510s and a gap region. The fifth slot pattern 1550s may be formed to connect a point of the fourth slot pattern 1540s and the gap region.

The fourth slot pattern 1540s may be arranged parallel to the second slot pattern 1520s between the first conductive pattern 1510 and the second slot pattern 1520s. The fourth slot pattern 1540s may be formed with a fourth slot length Lsb4 in the second axial direction. Referring to FIG. 14A, the fourth slot length Lsb4 may be adjusted in a certain range 81 based on a certain length Δout2. Referring to FIG. 14B, the fourth slot length Lsb4 may be adjusted in a certain range ε1 based on a certain length Δin2.

Referring to FIGS. 14A and 14B, the fourth slot length Ls4 of the fourth slot pattern 1540s may be smaller than the slot length of the second slot pattern 1520s. An end portion of the fourth slot pattern 1540s may be located more inward than an end portion of the second slot pattern 1520s. The fifth slot pattern 1550s may be connected to the fourth slot pattern 1540s. The fifth slot pattern 1550s may be formed to connect a point on an inner side of the fourth slot pattern 1540s and the gap region.

The first conductive pattern 1510 may be configured to include a plurality of sub-patterns. In this regard, the first conductive pattern 1510 may include a first sub-pattern 1511 and a second sub-pattern 1512. The first sub-pattern 1511 may be formed in the first axial direction. The second sub-pattern 1512 may be connected to the first sub-pattern 1511. The second sub-pattern 1512 may be formed in the second axial direction perpendicular to the first axial direction. The first slot pattern 1510s to the third slot pattern 1530s may be arranged on the second conductive pattern 1520 which is spaced apart from the outer boundary of the first conductive pattern 1510. Accordingly, the RF choke implemented as the slot pattern 1500s may be arranged on the second conductive pattern 1520 formed on the outer side of the first conductive pattern 1510. The RF choke arranged on the second conductive pattern 1520 formed on the outer side of the first conductive pattern 1510 may be referred to as an outer-form RF choke.

The RF choke may be arranged on the second conductive pattern 1520 formed on the outer side of the first conductive pattern 1510 or on a third conductive pattern 1530 which is formed on the inner side of the first conductive pattern 1510. Referring to FIG. 14B, the RF choke arranged on the third conductive pattern 1530 may be arranged on the third conductive pattern 1530 which is formed on the inner side of the first conductive pattern 1510. The RF choke arranged on the third conductive pattern 1530 formed on the inner side of the first conductive pattern 1510 may be referred to as an inner-form RF choke.

The third conductive pattern 1530 may be formed spaced apart from the inner boundary of the first sub-pattern 1511 and the second sub-pattern 1512 of the first conductive pattern 1510. The first slot pattern 1510s to the third slot pattern 1510s may be arranged on the third conductive pattern 1530 on the inner side of the first conductive pattern 1510 to be spaced apart from the inner boundary of the first conductive pattern 1510.

Referring to FIGS. 14A and 14B, the RF choke implemented in the antenna assembly may further include a via hole 1500v and a metal stub 1500 ms. The via hole 1500v may be arranged in a region between the second slot pattern 1520s and the third slot pattern 1530s and the gap region. The via hole 1500v may be configured to vertically connect a conductive pattern which is formed on the rear surface of a second dielectric substrate 1010c.

The metal stub 1500 ms may be arranged on the rear surface of the dielectric substrate and may be connected to the via hole 1500v. The metal stub 1500 ms may be configured to include a plurality of sub-patterns. In this regard, the metal stub 1500 ms may include a third sub-pattern 1510sb and a fourth sub-pattern 1520sb. The third sub-pattern 1510sb may be arranged on the rear surface of the dielectric substrate and connected to the via hole 1500v. The fourth sub-pattern 1520sb may be connected to the third sub-pattern 1510sb. Referring to FIG. 14A, an outer boundary of the fourth sub-pattern 1520sb of the metal stub 1500 ms may be spaced apart from an inner boundary of the second slot pattern 1520s by a gap distance Gin. The gap distance Gin may be adjusted in a certain range ε1 based on a specific gap distance GMout2. Referring to FIG. 14B, an inner boundary of the fourth sub-pattern 1520sb of the metal stub 1500 ms may be spaced apart from an outer boundary of the second slot pattern 1520s by a gap distance Gin. The gap distance Gin may be adjusted in a certain range ε1 based on a specific gap distance GMin.

The via hole 1500v of the outer-form RF choke structure shown in FIG. 14A may be arranged between an upper region of the first sub-pattern 1510 and a lower region of the first slot pattern 1510s. The via hole 1500v of the inner-form RF choke structure shown in FIG. 14B may be arranged between a lower region of the first sub-pattern 1510 and an upper region of the first slot pattern 1510s.

The fourth slot length Lsb4 of the fourth slot pattern 1540s of the RF choke operating in a dual band may be smaller than ¼ of a second wavelength λ2 which corresponds to a second target frequency of the Wi-Fi band. The first target frequency and the second target frequency of the Wi-Fi band may be set to a frequency in the range of 2.4 to 2.5 GHz and a frequency in the range of 5.15 to 5.85 GHZ, respectively. The first wavelength λ1 corresponding to the first target frequency of the Wi-Fi band may be set to be greater than the second wavelength λ2 corresponding to the second target frequency of the Wi-Fi band. The gap distance Gin between the metal stubs 1510sb and 1520sb and the second slot pattern 1520s for the RF choke operating in the dual band may be determined according to a width Wsb1 of the first slot pattern 1510s, the first wavelength λ1, and the second wavelength λ2. The gap distance Gin may be determined in proportion to Wsb1*λ2/λ1.

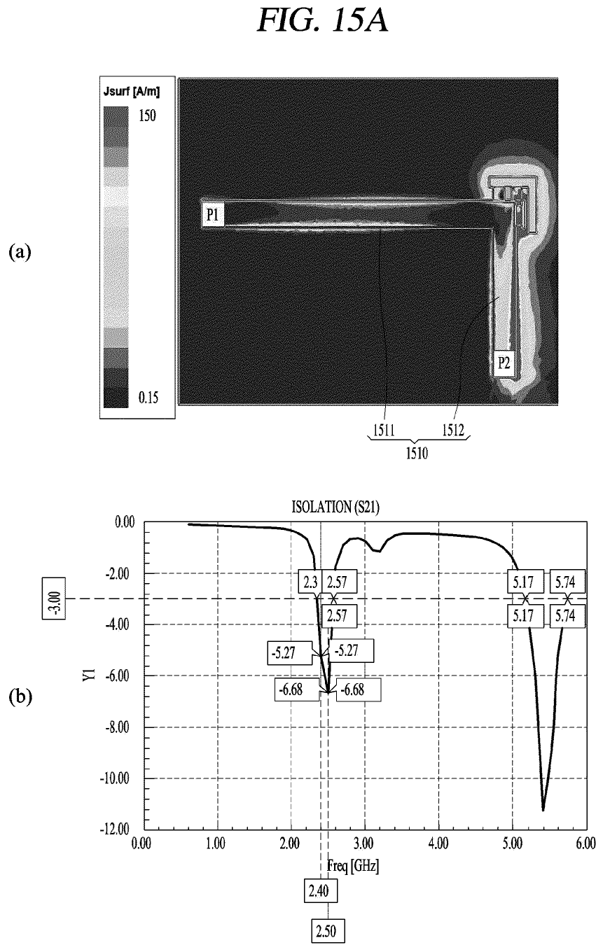

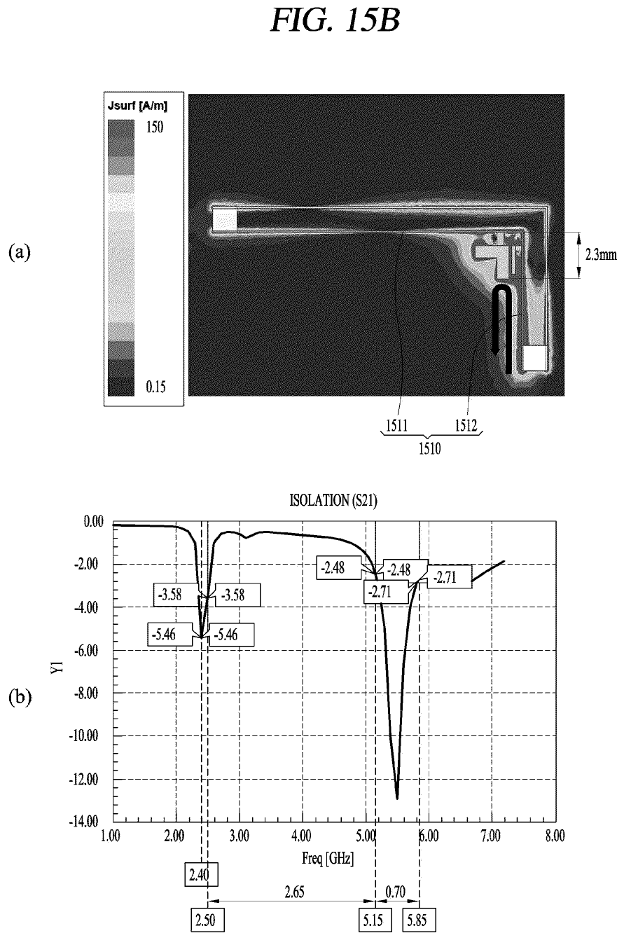

As described above, the RF choke configured as the slot pattern operating in the dual band according to the specification may be arranged in the outer region or the inner region of the first conductive pattern. In this regard, FIG. 15A is a view of current distribution and isolation characteristics of the RF choke structure which is arranged in the outer region of the first conductive pattern and operates in the dual band. FIG. 15B is a view of current distribution and isolation characteristics of the RF choke structure which is arranged in the inner region of the first conductive pattern and operates in the dual band.

Referring to FIG. 14A and (a) of FIG. 15A, a signal applied from a first port P1, which is one end portion of a first sub-pattern 1511 of the first conductive pattern 1510, may be reflected from the first slot pattern 1510s. The lengths of the first and second slot patterns 1510s and 1520s may be about a ¼ wavelength in a first Wi-Fi frequency band, and thus a remaining signal which is transmitted without being reflected from the first slot pattern 1510s be reflected from another end portion of the second slot pattern 1520s. The lengths of the fourth and fifth slot patterns 1540s and 1550s may be about a ¼ wavelength in a second Wi-Fi frequency band, such that a signal may be reflected. Accordingly, a current distribution in the slot pattern 1500s including the first to fifth slot patterns 1510s to 1550s and a region adjacent to the slot pattern 1500s may be higher than a current distribution in other regions.

Referring to FIG. 14A and (b) of FIG. 15A, a signal transmitted to a second port P2, which is another end portion of a second sub-pattern 1512 of the first conductive pattern 1510, may be below a threshold level in the Wi-Fi frequency band. An isolation characteristic value between the first and second ports P1 and P2 may be −5.2 dB or less in a frequency band of 2.4 to 2.5 GHz due to the RF choke. In this regard, a first slot length Ls1 of the first slot pattern 1510s may be formed in a certain range based on 4.7 mm. A second slot length Ls2 of the second slot pattern 1520s may be formed in a certain range based on 4.62 mm. An isolation characteristic value between the first and second ports P1 and P2 may be −3 dB or less in a frequency band of 5.17 to 5.74 GHz due to the RF choke. In this regard, a fourth slot length Lsb4 of the fourth slot pattern 1540s may be formed in a certain range based on 2.1 mm.

Referring to FIG. 14B and (a) of FIG. 15B, a signal applied from a first port P1, which is one end portion of a first sub-pattern 1511 of the first conductive pattern 1510, may be reflected from the first slot pattern 1510s. The lengths of the first and second slot patterns 1510s and 1520s may be about a ¼ wavelength in a first Wi-Fi frequency band, and thus a remaining signal which is transmitted without being reflected from the first slot pattern 1510s be reflected from another end portion of the second slot pattern 1520s. The lengths of the fourth and fifth slot patterns 1540s and 1550s may be about a ¼ wavelength in a second Wi-Fi frequency band, such that a signal may be reflected. Accordingly, a current distribution in the slot pattern 1500s including the first to fifth slot patterns 1510s to 1550s and a region adjacent to the slot pattern 1500s may be higher than a current distribution in other regions.

Referring to FIG. 14B and (b) of FIG. 15B, a signal transmitted to a second port P2, which is another end portion of a second sub-pattern 1512 of the first conductive pattern 1510, may be below a threshold level in the Wi-Fi frequency band. An isolation characteristic value between the first and second ports P1 and P2 may be −3.5 dB or less in a frequency band of 2.4 to 2.5 GHz due to the RF choke. In this regard, the first slot length Ls1 of the first slot pattern 1510s may be formed in a certain range based on 3.2 mm. The second slot length Ls2 of the second slot pattern 1520s may be formed in a certain range based on 3.12 mm. An isolation characteristic value between the first and second ports P1 and P2 may be −2.48 dB or less in a frequency band of 5.15 to 5.85 GHz due to the RF choke. In this regard, the fourth slot length Lsb4 of the fourth slot pattern 1540s may be formed in a certain range based on 2.3 mm.

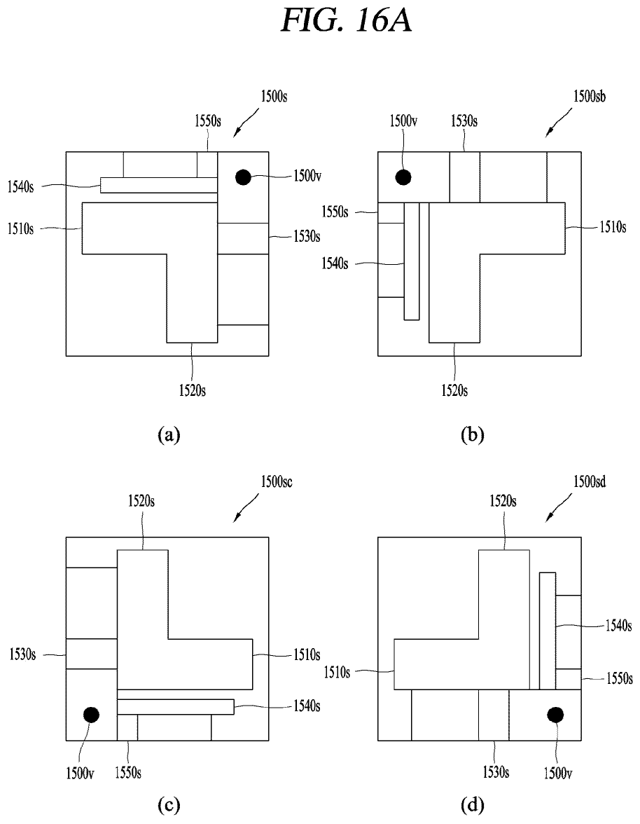

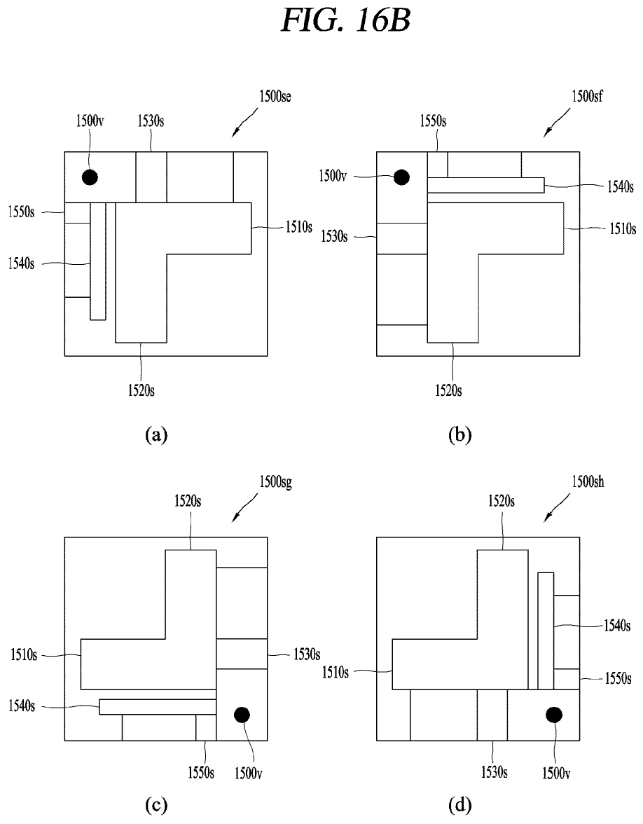

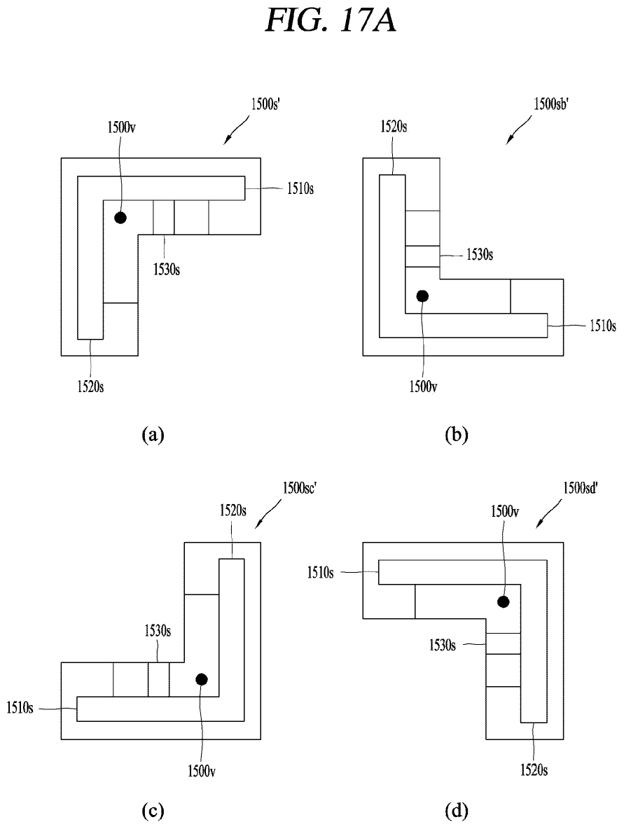

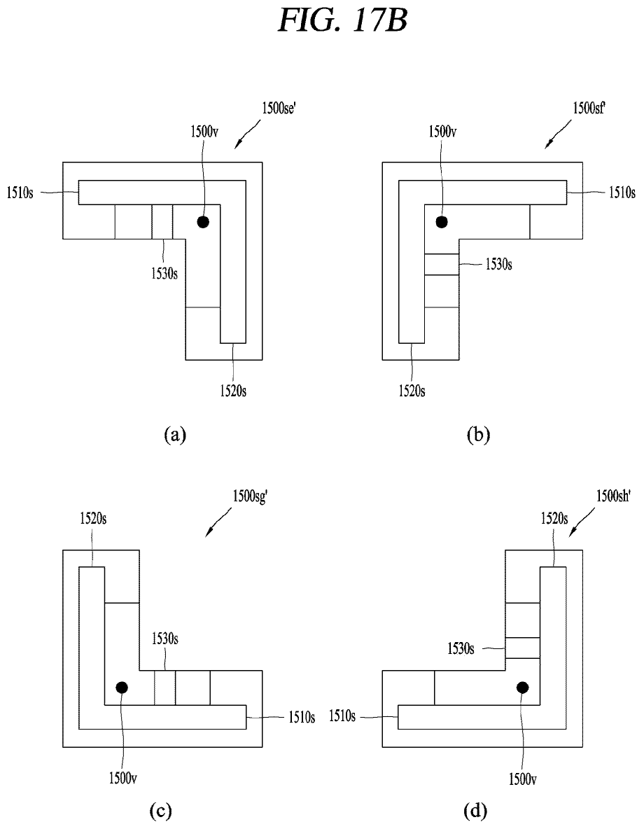

In some embodiments, the RF choke implemented as the slot pattern according to the specification may be realized with various shapes and structures as described above. In this regard, FIGS. 16A and 16B are views of shapes and structures of inner-form RF chokes, which are implemented as slot patterns, according to embodiments. FIGS. 17A and 17B are views of shapes and structures of outer-form RF chokes, which are implemented as slot patterns, according to embodiments.

Referring to FIGS. 14B, 16A, and 16B, the slot pattern 1500s may be arranged in the inner region of the conductive pattern 1510. The slot pattern 1500s may be configured to reflect (or block) signals in a dual band, namely, the first Wi-Fi frequency band of 2.4 to 2.5 GHz and the second Wi-Fi frequency band of 5.15 to 5.85 GHz.

Referring to (a) of FIG. 16A, a slot pattern 1500s may include a first slot pattern 1510s to a fifth slot pattern 1550s. One end portion of the second slot pattern 1520s may be vertically connected to another end portion of the first slot pattern 1510s and may extend downward. The third slot pattern 1530s may be connected to a point of the second slot pattern 1520s and may extend to right. The fourth slot pattern 1540s may be arranged in another axial direction to be parallel to the first slot pattern 1510s. Another end portion of the fifth slot pattern 1550s may be vertically connected to another end portion of the fourth slot pattern 1540 and may extend upward.

Referring to (b) of FIG. 16A, a slot pattern 1500sb may include a first slot pattern 1510s to a fifth slot pattern 1550s. One end portion of the second slot pattern 1520s may be vertically connected to one end portion of the first slot pattern 1510s and may extend downward. The third slot pattern 1530s may be connected to a point of the first slot pattern 1510s and may extend upward. The fourth slot pattern 1540s may be arranged in one axial direction to be parallel to the second slot pattern 1520s. Another end portion of the fifth slot pattern 1550s may be vertically connected to another end portion of the fourth slot pattern 1540 and may extend to left.

Referring to (c) of FIG. 16A, a slot pattern 1500sc may include a first slot pattern 1510s to a fifth slot pattern 1550s. Another end portion of the second slot pattern 1520s may be vertically connected to one end portion of the first slot pattern 1510s and may extend upward. The third slot pattern 1530s may be connected to a point of the second slot pattern 1520s and may extend to left. The fourth slot pattern 1540s may be arranged in another axial direction to be parallel to the first slot pattern 1510s. One end portion of the fifth slot pattern 1550s may be vertically connected to one end portion of the fourth slot pattern 1540 and may extend downward.

Referring to (d) of FIG. 16A, a slot pattern 1500sd may include a first slot pattern 1510s to a fifth slot pattern 1550s. Another end portion of the second slot pattern 1520s may be vertically connected to another end portion of the first slot pattern 1510s and may extend upward. The third slot pattern 1530s may be connected to a point of the first slot pattern 1510s and may extend downward. The fourth slot pattern 1540s may be arranged in one axial direction to be parallel to the second slot pattern 1520s. One end portion of the fifth slot pattern 1550s may be vertically connected to another end portion of the fourth slot pattern 1540 and may extend to right.

Referring to (a) of FIG. 16B, the slot pattern 1500se may include a first slot pattern 1510s to a fifth slot pattern 1550s. One end portion of the second slot pattern 1520s may be vertically connected to one end portion of the first slot pattern 1510s and may extend downward. The third slot pattern 1530s may be connected to a point of the second slot pattern 1520s and may extend to left. The fourth slot pattern 1540s may be arranged in another axial direction to be parallel to the first slot pattern 1510s. Another end portion of the fifth slot pattern 1550s may be vertically connected to one end portion of the fourth slot pattern 1540 and may extend upward.

Referring to (b) of FIG. 16B, the slot pattern 1500sf may include a first slot pattern 1510s to a fifth slot pattern 1550s. Another end portion of the second slot pattern 1520s may be vertically connected to one end portion of the first slot pattern 1510s and may extend upward. The third slot pattern 1530s may be connected to a point of the first slot pattern 1510s and may extend downward. The fourth slot pattern 1540s may be arranged in one axial direction to be parallel to the second slot pattern 1520s. Another end portion of the fifth slot pattern 1550s may be vertically connected to another end portion of the fourth slot pattern 1540 and may extend to left.

Referring to (c) of FIG. 16B, the slot pattern 1500sg may include a first slot pattern 1510s to a fifth slot pattern 1550s. One end portion of the second slot pattern 1520s may be vertically connected to another end portion of the first slot pattern 1510s and may extend upward. The third slot pattern 1530s may be connected to a point of the second slot pattern 1520s and may extend to right. The fourth slot pattern 1540s may be arranged in another axial direction to be parallel to the first slot pattern 1510s. One end portion of the fifth slot pattern 1550s may be vertically connected to another end portion of the fourth slot pattern 1540 and may extend downward.

Referring to (d) of FIG. 16B, the slot pattern 1500sh may include a first slot pattern 1510s to a fifth slot pattern 1550s. One end portion of the second slot pattern 1520s may be vertically connected to another end portion of the first slot pattern 1510s and may extend downward. The third slot pattern 1530s may be connected to a point of the first slot pattern 1510s and may extend upward. The fourth slot pattern 1540s may be arranged in one axial direction to be parallel to the second slot pattern 1520s. One end portion of the fifth slot pattern 1550s may be vertically connected to one end portion of the fourth slot pattern 1540 and may extend to right.

Referring to FIGS. 14B, 17A, and 17B, the slot pattern 1500s may be arranged in the outer region of the conductive pattern 1510. The slot pattern 1500s may be configured to reflect (or block) signals in the Wi-Fi frequency band of 2.4 to 2.5 GHz.

Referring to (a) of FIG. 17A, a slot pattern 1500s′ may include a first slot pattern 1510s to a third slot pattern 1530s. One end portion of the second slot pattern 1520s may be vertically connected to one end portion of the first slot pattern 1510s and may extend downward. The third slot pattern 1530s may be connected to a point of the first slot pattern 1520s and may extend downward.

Referring to (b) of FIG. 17A, a slot pattern 1500sb′ may include a first slot pattern 1510s to a third slot pattern 1530s. Another end portion of the second slot pattern 1520s may be vertically connected to one end portion of the first slot pattern 1510s and may extend upward. The third slot pattern 1530s may be connected to a point of the second slot pattern 1520s and may extend to right.

Referring to (c) of FIG. 17A, a slot pattern 1500sc′ may include a first slot pattern 1510s to a third slot pattern 1530s. One end portion of the second slot pattern 1520s may be vertically connected to another end portion of the first slot pattern 1510s and may extend upward. The third slot pattern 1530s may be connected to a point of the first slot pattern 1510s and may extend upward.

Referring to (d) of FIG. 17A, a slot pattern 1500sd′ may include a first slot pattern 1510s to a third slot pattern 1530s. One end portion of the second slot pattern 1520s may be vertically connected to another end portion of the first slot pattern 1510s and may extend downward. The third slot pattern 1530s may be connected to a point of the second slot pattern 1520s and may extend to left.

Referring to (a) of FIG. 17B, a slot pattern 1500se′ may include a first slot pattern 1510s to a third slot pattern 1530s. One end portion of the second slot pattern 1520s may be vertically connected to another end portion of the first slot pattern 1510s and may extend downward. The third slot pattern 1530s may be connected to a point of the first slot pattern 1520s and may extend downward.

Referring to (b) of FIG. 17B, a slot pattern 1500sf′ may include a first slot pattern 1510s to a third slot pattern 1530s. One end portion of the second slot pattern 1520s may be vertically connected to one end portion of the first slot pattern 1510s and may extend downward. The third slot pattern 1530s may be connected to a point of the second slot pattern 1520s and may extend to right.

Referring to (c) of FIG. 17B, a slot pattern 1500sg′ may include a first slot pattern 1510s to a third slot pattern 1530s. One end portion of the second slot pattern 1520s may be vertically connected to one end portion of the first slot pattern 1510s and may extend downward. The third slot pattern 1530s may be connected to a point of the second slot pattern 1510s and may extend to right.

Referring to (d) of FIG. 17B, a slot pattern 1500sh′ may include a first slot pattern 1510s to a third slot pattern 1530s. One end portion of the second slot pattern 1520s may be vertically connected to another end portion of the first slot pattern 1510s and may extend upward. The third slot pattern 1530s may be connected to a point of the second slot pattern 1520s and may extend to left.

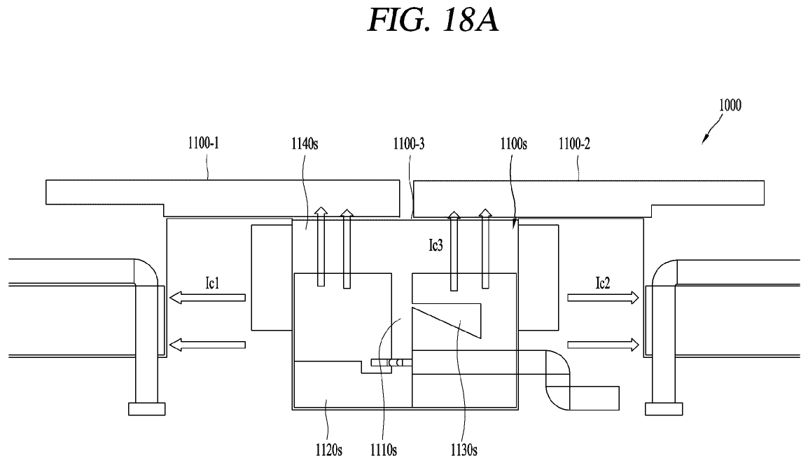

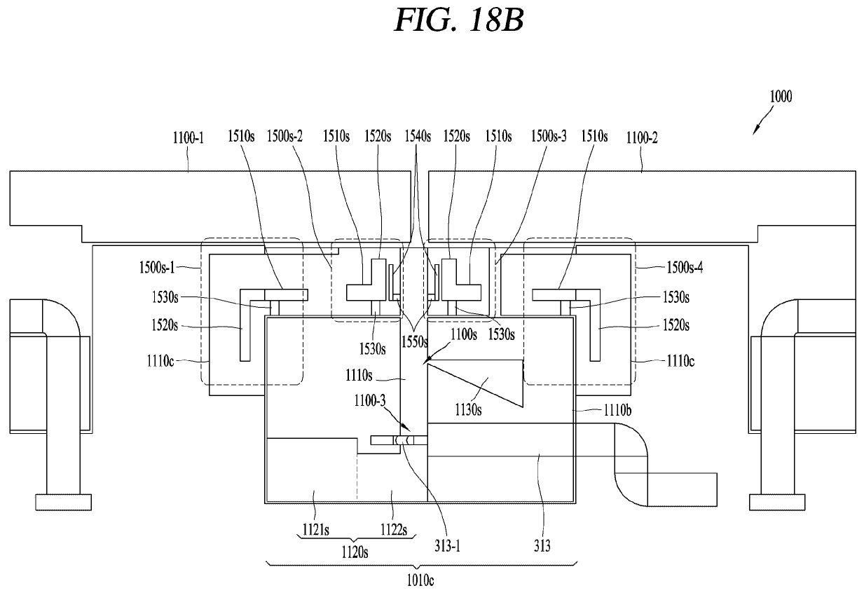

An RF choke implemented as a slot pattern according to the specification may be implemented inside a transparent antenna assembly. In this regard, FIG. 18A is a conceptual view in which a current of a Wi-Fi antenna arranged between transparent antennas causes interference with the adjacent transparent antennas. FIG. 18B is a view of RF chokes arranged adjacent to slot patterns of a Wi-Fi antenna arranged between transparent antennas.

Referring to FIG. 18A, the antenna assembly 1000 may include a third antenna 1100-3 arranged between a first transparent antenna 1100-1 and a second transparent antenna 1100-2. The third antenna 1100-3 may be implemented as a slot antenna region 1100s which operates in a Wi-Fi frequency band.

The slot antenna region 1100s may include a plurality of slot regions. The slot antenna region 1100s may include a first slot region 1110s and a second slot region 1120s and a third slot region 1130s arranged on one side and another side of the first slot region 1110s. The slot antenna region 1100s may include a fourth slot region 1140s connected to an upper end of the first slot region 1110s. The slot antenna region 1100s may have a structure in which RF chokes are not arranged adjacent to the first slot region 1110s to the fourth slot region 1140s. Accordingly, a first current Ic1, a second current Ic2, and a third current Ic3 may be transmitted to one side region, another side region, and an upper region of the first slot region 1110s. Depending on the first current Ic1, the second current Ic2, and the third current Ic3, a current of the third antenna 1100-3 may cause interferences with regions where the first and second transparent antennas 1100-1 and 1100-2 are arranged.

Referring to FIG. 18B, conductive patterns 1110b and 1110c may be formed on one surface of a dielectric substrate 1010c, and the slot antenna region 1100s and a slot pattern 1500s may be formed on the conductive patterns 1110b and 1110c. The slot antenna region 1100s may include a first slot region 1110s and a second slot region 1120s and a third slot region 1130s which are arranged on one side and another side of the first slot region 1110s. The slot pattern 1500s which operates as the RF chokes may be arranged on the dielectric substrate 1010c on which the third antenna 1100-3 as a Wi-Fi antenna is implemented. An electric field distribution formed in the first slot region 1110s and the first slot pattern 1510s to the third slot region 1130s may be formed higher than an electric field distribution in other regions where the conductive patterns 1110b and 1120b are arranged.

The slot pattern 1500s which operates as the RF chokes may include a first slot structure 1500s-1 to a fourth slot structure 1500s-4. The first slot structure 1500s-1 and the second slot structure 1500s-2 may be outer-form RF chokes arranged in the outer region of the conductive pattern 1110b. The third slot structure 1500s-3 and the fourth slot structure 1500s-4 may be inner-form RF chokes which are arranged in the inner region of the conductive pattern 1120b and operate in a dual band. The electric field distribution in a region adjacent to the first slot structure 1500s-1 to the fourth slot structure 1500s-4 may be formed higher than the electric field distribution in other regions where the conductive patterns 1110b and 1120b are arranged.

The first slot structure 1500s-1 may include a first slot pattern 1510s to a third slot pattern 1530s and may reflect (block) signals in the first Wi-Fi frequency band. The second slot structure 1500s-2 may also include a first slot pattern 1510s to a third slot pattern 1530s and may reflect (block) signals in the first Wi-Fi frequency band. The second slot structure 1500s-2 may be formed in a symmetrical shape with the first slot structure 1500s-1 based on the conductive pattern 1110b, 1120b (or the first slot region 1110s). The structures for the first slot pattern 1510s to the third slot pattern 1530s will be understood by the foregoing description.

The third slot structure 1500s-3 may include a first slot pattern 1510s to a fifth slot pattern 1550s and may reflect (block) signals in the first Wi-Fi frequency band and the second Wi-Fi frequency band. The fourth slot structure 1500s-4 may also include a first slot pattern 1510s to a fifth slot pattern 1550s and may reflect (block) signals in the first Wi-Fi frequency band and the second Wi-Fi frequency band. The fourth slot structure 1500s-4 may be formed in a symmetrical shape with the third slot structure 1500s-3 based on the conductive pattern 1110b, 1120b (or the first slot region 1110s). The structures for the first slot pattern 1510s to the third slot pattern 1530s will be understood by the foregoing description.

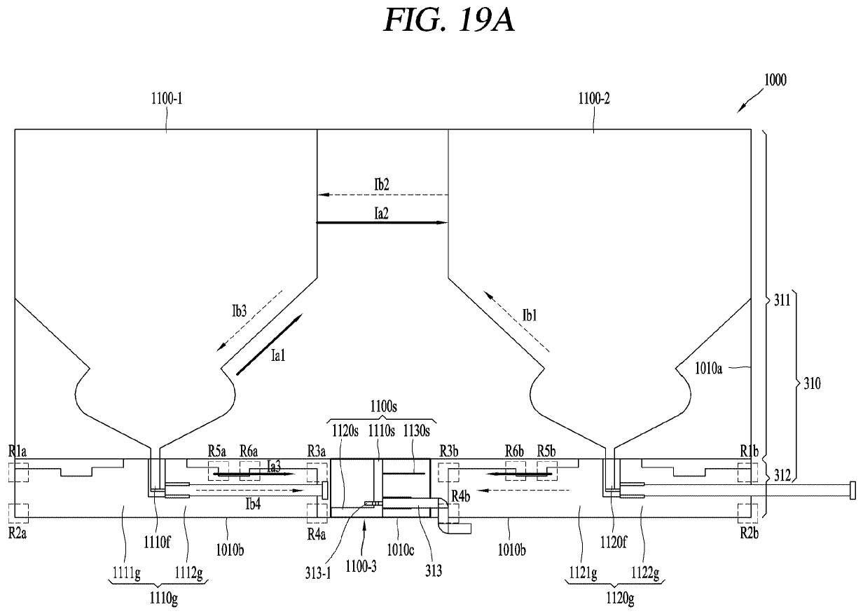

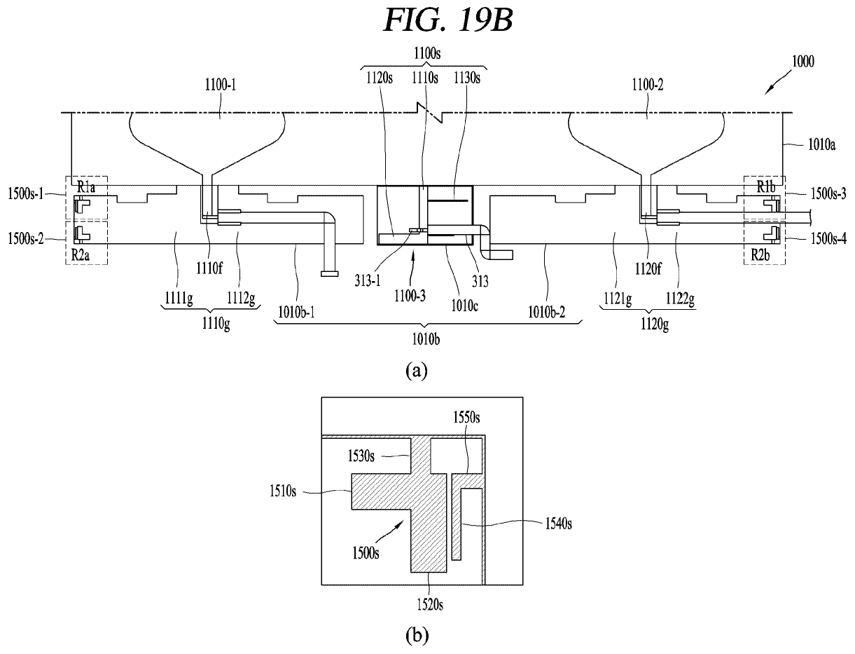

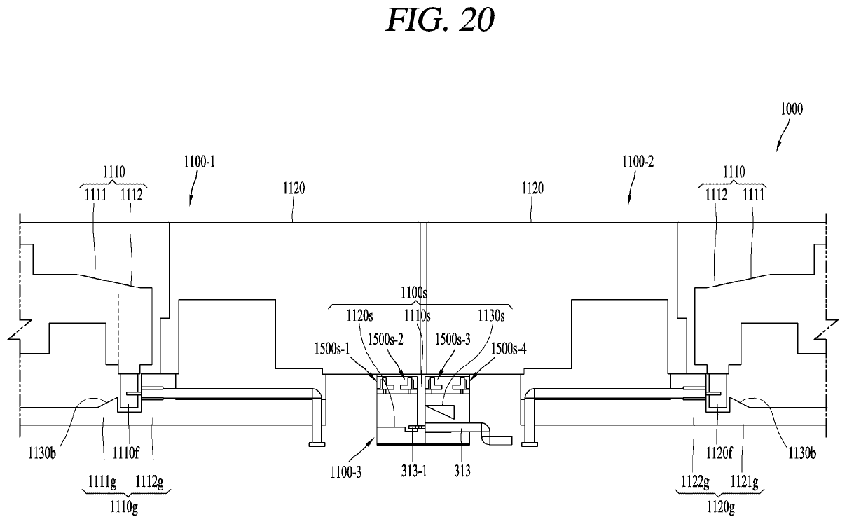

An RF choke implemented as a slot pattern according to the specification may be implemented inside a transparent antenna assembly. In this regard, FIG. 19A is a view of regions where RF chokes implemented as slot patterns may be formed on a dielectric substrate which feeds power to transparent antennas. FIG. 19B is a view of RF chokes formed on a dielectric substrate which feeds power to transparent antennas. FIG. 20 is a view of an antenna assembly having first and second transparent antennas implemented with a plurality of conductive patterns.

Referring to FIG. 19A, a glass panel 310 may include a transparent region 311 and an opaque region 312. The opaque region 312 may be arranged in a frit region. Feeding patterns 1110f and 1120f of transparent antennas 1100-1 and 1100-2 may be arranged in the frit region. Due to a limited space of the frit region formed in the glass panel 310, a vertical axial length of a second dielectric substrate 1010b which is implemented as a feeding FPCB must be implemented to be less than a certain length. In other embodiments, for stable impedance matching of 4G/5G wideband MIMO transparent antennas 1100-1 and 1100-2, an FPCB region may be expanded to left and right.

Accordingly, in case that a Wi-Fi antenna implemented in a film form is arranged inside the structure of the antenna assembly 100, an induced current may be generated in the Wi-Fi antenna by currents generated from the transparent antennas and the feeding patterns. The induced current may cause losses in isolation and performance between the transparent antenna and the Wi-Fi antenna. In this regard, a first current Ial generated along one side of the conductive pattern of the first transparent antenna 1100-1 may be coupled to the conductive pattern of the second transparent antenna 1100-2 by a second current Ia2. The first current Ial may be coupled to the second dielectric substrate 1010b by a third current Ia3. The second current Ia2 may be coupled to the second dielectric substrate 1010b by a fourth current la4. Therefore, the third current Ia3 and the fourth current Ia4 may cause interference with the third antenna 1100-3 operating as the Wi-Fi antenna. Accordingly, RF chokes implemented as slot patterns need to be formed in a third region R3a, R3b to a sixth region R6a, R6b of the second dielectric substrate 1010b.

A first current Ib1 generated along one side of the conductive pattern of the second transparent antenna 1100-2 may be coupled to the conductive pattern of the first transparent antenna 1100-1 by a second current Ib2. A third current Ib3 may be formed along one side of the conductive pattern of the first transparent antenna 1100-1 by the second current Ib2. The third current Ib3 may be coupled to the second dielectric substrate 1010b by a fourth current Ib4. The first current Ib1 may be coupled to the second dielectric substrate 1010b by a fifth current Ib5. Therefore, the fourth current Ib4 and the fifth current Ib5 may cause interference with the third antenna 1100-3 operating as the Wi-Fi antenna. Accordingly, RF chokes implemented as slot patterns need to be formed in a third region R3a, R3b to a sixth region R6a, R6b of the second dielectric substrate 1010b.

Therefore, RF chokes may be formed to reflect (block) interference signals to the second dielectric substrate 1010b which is arranged in the opaque region 312 in the antenna assembly according to the specification. The RF chokes may be formed as slot patterns. The slot patterns of the RF chokes may be formed in a one-dimensional structure in one axial direction. As another example, the slot patterns of the RF chokes may be designed as a two-dimensional planar structure in one axial direction and another axial direction. The RF chokes formed as the slot patterns with the two-dimensional planar structure may be implemented in a narrow space of the conductive pattern formed on the dielectric substrate. This may result from that a length of a slot/stub of an RF choke is implemented to be at least ¼ of a wavelength corresponding to a target frequency. As described above, the RF Choke may include first to third slot patterns to block a current flow in a single frequency band, i.e., the first Wi-Fi frequency band, for example, the frequency band of 2.4 to 2.5 GHZ. As another example, the RF Choke may include first to fifth slot patterns to block a current flow in the first and second Wi-Fi frequency bands, which are a multi-frequency band. The second Wi-Fi frequency band may be set to a frequency band ranging from 5.15 to 5.85 GHz. Accordingly, a structure is proposed in which an RF Choke is arranged at an edge of a ground region of an FPCB to block a current flow of a Wi-Fi antenna where double resonance occurs.

The first feeding pattern 1110f configured to apply a signal to the first transparent antenna 1100-1 may be formed on the dielectric substrate 1010b. A first ground region 1110g may be formed on one side and another side of the first feeding pattern 1110f. The first ground region 1110g may include a first part 1111g formed on the one side of the first feeding pattern 1110f and a second part 1112g formed on the other side of the first feeding pattern 1110f.

RF chokes implemented as slot patterns may be formed in a first region Rla on one side and upper portion of the first part 1111g and a second region R2a on one side and lower portion of the first part 1111g. RF chokes implemented as slot patterns may be formed in a third region R3a on one side and upper portion of the second part 1112g and a fourth region R4a on one side and lower portion of the second part 1112g. RF chokes implemented as slot patterns may be formed in a fifth region R5a and a sixth region R6a, each having a step, on the upper portion of the second part 1112g. In this regard, the RF chokes implemented as the slot patterns may be one of the various RF chokes described above, for example, one of the inner/outer-form single-band structure or dual-band structure.

The second feeding pattern 1120f configured to apply a signal to the second transparent antenna 1100-2 may be formed on the dielectric substrate 1010b. A second ground region 1120g may be formed on one side and another side of the first feeding pattern 1110f. The second ground region 1120g may include a third part 1121g formed on the one side of the second feeding pattern 1110f and a fourth part 1122g formed on the other side of the second feeding pattern 1110f.

RF chokes implemented as slot patterns may be formed in a first region R1b on one side and upper portion of the fourth part 1122g and a second region R2b on one side and lower portion of the fourth part 1122g. RF chokes implemented as slot patterns may be formed in a third region R3b on one side and upper portion of the third part 1121g and a fourth region R4b on one side and lower portion of the third part 1121g. RF chokes implemented as slot patterns may be formed in a fifth region R5b and a sixth region R6b, each having a step, on the upper portion of the third part 1121g. In this regard, the RF chokes implemented as the slot patterns may be one of the various RF chokes described above, for example, one of the inner/outer-form single-band structure or dual-band structure.

Referring to FIGS. 19A and 19B, the antenna assembly 1000 may be arranged on the glass panel 310 of the vehicle. The glass panel 310 may include the transparent region 311 and the opaque region 312. The antenna assembly 1000 may include the first dielectric substrate 1010a which is a transparent substrate, and the second dielectric substrates 1010b and 1010c which are opaque substrates. The first transparent antenna 1100-1 and the second transparent antenna 1100-2 may be arranged on the first dielectric substrate 1010a. The first feeding pattern 11110f and the second feeding pattern 1120f may be arranged on the second dielectric substrate 1010b. The first ground region 1110g may be formed on one side and another side of the first feeding pattern 1110f. The second ground region 1110g may be formed on one side and another side of the second feeding pattern 1120f.

The first transparent antenna 1100-1 and the second transparent antenna 1100-2 may be configured to emit signals of a first frequency band to a third frequency band for 4G/5G wireless communications. The first transparent antenna 1100-1 and the second transparent antenna 1100-2 may perform a multiple input/multiple output (MIMO) operation by transmitting or receiving signals of the same frequency band. The first and second transparent antennas 1100-1 and 1100-2 may each include a plurality of conductive patterns to emit signals of the first to third frequency bands.

Referring to FIG. 20, first and second antennas 1100-1 and 1100-2 may each include first to third conductive patterns. The first antenna 1100-1 may include a first conductive pattern 1110, a second conductive pattern 1120, and a third conductive pattern 1130b. The second antenna 1100-2 may also include a first conductive pattern 1110, a second conductive pattern 1120, and a third conductive pattern 1130b. The first conductive pattern 1110 and the second conductive pattern 1120 may operate as radiators in the first frequency band. The first conductive pattern 1110 may operate as a radiator in the second frequency band. The first conductive pattern 1110 and the second conductive pattern 1120 may be implemented as transparent antennas made of a transparent material. The third conductive pattern 1130b may operate as a radiator in the third frequency band. The third dielectric substrate 1130b may be implemented as an antenna made of an opaque material, but is not limited thereto.

Referring to FIGS. 19A to 20, the first frequency band may be a low band (LB) of 4G/5G wireless communication. The first frequency band may be set to 617 to 960 MHZ, but is not limited thereto. The second frequency band may be a mid band (MB) of 4G/5G wireless communication. The second frequency band may be set to 1520 to 4500 MHZ, but is not limited thereto. A part of the second frequency band may overlap a part of the first Wi-Fi frequency band, which may cause interference between signals. The third frequency band may be a high band (HB) 4G/5G wireless communication. The third frequency band may be set to 4500 to 6000 MHz, but is not limited thereto. A part of the third frequency band may overlap a part of the second Wi-Fi frequency band, which may cause interference between signals.

The second dielectric substrate 1010b on which the first feeding pattern 1110f and the second feeding pattern 1120f are arranged may be formed as a separate substrate. The second dielectric substrate 1010b may be implemented as a flexible printed circuit board (FPCB). Another second dielectric substrate 1010c may be arranged between second dielectric substrates 1010b-1 and 1010b-2 on which the first feeding pattern 1110f and the second feeding pattern 1120f are formed. A slot antenna region 1100s formed on the second dielectric substrate 1010c may be configured to emit signals in the Wi-Fi frequency band. The slot antenna area 1100s may operate as a third antenna 1100-3 which emits signals in the Wi-Fi frequency band.

Referring to FIGS. 19A and 19B, a first slot structure 1500s-1 may be formed in the first region Rla which is located on one side and an upper portion of the first part 1111g of the first ground region 1110g. A slot structure 1500s-2 may be formed in the second region R2a which is located on one side and a lower portion of the first part 1111g of the first ground region 1110g. The first slot structure 1500s-1 and the second slot structure 1500s-2, as shown in FIG. 18 and (b) of FIG. 19B, may each include the first slot pattern 1510s to the fifth slot pattern 1550s, but are not limited thereto.

A third slot structure 1500s-3 may be formed in the first region R1b which is located on one side and an upper portion of the fourth part 1122g of the second ground region 1120g. A fourth slot structure 1500s-4 may be formed in the second region R2b which is located on one side and a lower portion of the fourth part 1122g of the second ground region 1120g. The third slot structure 1500s-3 and the fourth slot structure 1500s-4, as shown in FIG. 18 and (b) of FIG. 19B, may each include the first slot pattern 1510s to the fifth slot pattern 1550s, but are not limited thereto.

Referring to FIG. 20, the first to fourth slot structures 1500s-1 to 1500s-4 implemented as the slot patterns may be formed on the conductive patterns of the second dielectric substrate 1010c. Each of the first to fourth slot structures 1500s-1 to 1500s-4 may be implemented to operate in a dual band, but is not limited thereto. Each of the first to fourth slot structures 1500s-1 to 1500s-4 may include the first slot pattern 1510s to the fifth slot pattern 1540s as shown in (b) of FIG. 19B.

Hereinafter, a vehicle including an antenna assembly according to the specification will be described with reference to FIGS. 1A to 20. A glass panel 310 may include a transparent region 311 and an opaque region 312. An antenna assembly 1000 may be arranged on the glass panel 310. The antenna assembly 1000 may include a first dielectric substrate 1010a which is a transparent substrate, and second dielectric substrates 1010b and 1010c which are opaque substrates. The first dielectric substrate 1010a may be arranged in the transparent region 311 of the glass panel 310 and transparent antennas may be formed on one side surface of the first dielectric substrate 1010a. The second dielectric substrates 1010b and 1010c may be located in the opaque region 312 of the glass panel 310.

A slot antenna region 1100s which operates in a Wi-Fi frequency band may be formed on the second dielectric substrate 1010c. In some embodiments, an RF choke configured to block signals of the Wi-Fi frequency band according to the specification may include a plurality of conductive patterns and a plurality of slot patterns. In this regard, the antenna assembly 1000 may include an RF choke which includes a first conductive pattern 1510, a second conductive pattern 1520, and a slot pattern 1500s.

The first conductive pattern 1510 may be formed on the second dielectric substrate 1010c to have a first length in a first axial direction and a second length in a second axial direction. The second conductive pattern 1520 may be spaced apart from an outer boundary or an inner boundary of the first conductive pattern 1510 by a gap region. A slot pattern 1500s may be arranged parallel to the outer boundary of the first conductive pattern 1510 or an inner boundary of the first conductive pattern 1510 and configured to reflect a signal of a specific frequency band.

The slot pattern 1500s may include a first slot pattern 1510s and a second slot pattern 1520s. The slot pattern 1500s may further include a third slot pattern 1530s. The first slot pattern 1510s may be formed with a first slot length in the first axial direction, so that the signal of the specific frequency band may be reflected in an opposite direction on the first axis. The second slot pattern 1520s may be connected to the first slot pattern 1510s. The second slot pattern 1520s may be formed with a second slot length in the second axial direction. The third slot pattern 1530s may be formed to connect a point on the inside of the first slot pattern 1510s or the second slot pattern 1520s and the gap region on the outside of the first conductive pattern 1510.

The slot pattern 1500s of the RF choke according to the specification may be configured to block signals of different frequency bands through additional slot patterns. In some embodiments, the slot pattern 1500s may be configured to block signals of a first frequency band of 2.4 to 2.5 GHz and a second frequency band of 5.15 to 5.85 GHz. The slot pattern 1500s may be configured to further include first to third slot patterns 1510s to 1530s, a fourth slot pattern 1540s, and a fifth slot pattern 1550s. The third slot pattern 1530s may be formed to connect a point of the first slot pattern 1510s and a gap region.

The fourth slot pattern 1540s may be arranged parallel to the second slot pattern 1520s between the first conductive pattern 1510 and the second slot pattern 1520s. The fifth slot pattern 1550s may be connected to the fourth slot pattern 1540s. The fifth slot pattern 1550s may be formed to connect a point of an inner side of the fourth slot pattern 1540s and the gap region.

The first conductive patterns 1510 may be configured to include a plurality of sub-patterns. In this regard, the first conductive pattern 1510 may include a first sub-pattern 1511 and a second sub-pattern 1512. The first sub-pattern 1511 may be formed in the first axial direction. The second sub-pattern 1512 may be connected to the first sub-pattern 1511. The second sub-pattern 1512 may be formed in the second axial direction perpendicular to the first axial direction. The first slot pattern 1510s to the third slot pattern 1530s may be arranged on the second conductive pattern 1520 which is spaced apart from the outer boundary of the first conductive pattern 1510. Accordingly, the RF choke implemented as the slot pattern 1500s may be arranged on the second conductive pattern 1520 formed on the outer side of the first conductive pattern 1510. The RF choke arranged on the second conductive pattern 1520 formed on the outer side of the first conductive pattern 1510 may be referred to as an outer-form RF choke.

The RF choke may be arranged on the second conductive pattern 1520 formed on the outer side of the first conductive pattern 1510 or on a third conductive pattern 1530 which is formed on the inner side of the first conductive pattern 1510. The RF choke arranged on the third conductive pattern 1530 may be arranged on the third conductive pattern 1530 which is formed on the inner side of the first conductive pattern 1510. The RF choke arranged on the third conductive pattern 1530 formed on the inner side of the first conductive pattern 1510 may be referred to as an inner-form RF choke.

The third conductive pattern 1530 may be formed spaced apart from the inner boundary of the first sub-pattern 1511 and the second sub-pattern 1512 of the first conductive pattern 1510. The first slot pattern 1510s to the third slot pattern 1510s may be arranged on the third conductive pattern 1530 on the inner side of the first conductive pattern 1510 to be spaced apart from the inner boundary of the first conductive pattern 1510. The RF choke implemented in the antenna assembly may further include a via hole 1500v and a metal stub 1500 ms. The via hole 1500v may be arranged in a region between the second slot pattern 1520s and the third slot pattern 1530s and the gap region. The via hole 1500v may be configured to vertically connect a conductive pattern which is formed on the rear surface of the second dielectric substrate 1010c.

The metal stub 1500 ms may be arranged on the rear surface of the second dielectric substrate 1010c and may be connected to the via hole 1500v. The metal stub 1500 ms may be configured to include a plurality of sub-patterns. In this regard, the metal stub 1500 ms may include a third sub-pattern 1510sb and a fourth sub-pattern 1520sb. The third sub-pattern 1510sb may be arranged on the rear surface of the second dielectric substrate 1010c and connected to the via hole 1500v. The third sub-pattern 1510sb may be formed with a third length Ls3 in the first axial direction. The fourth sub-region 1520sb may be connected to the third sub-region 1510sb. The fourth sub-pattern 1520sb may be formed with a fourth length Ls4 in the second axial direction.

The via hole 1500v of the outer-form RF choke structure may be arranged between an upper region of the first sub-pattern 1510 and a lower region of the first slot pattern 1510s. The via hole 1500v of the inner-form RF choke structure may be arranged between a lower region of the first sub-pattern 1510 and an upper region of the first slot pattern 1510s.

The transparent antennas of the antenna assembly 1000 may include a first transparent antenna 1100-1 and a second transparent antenna 1100-2. The second dielectric substrate 1010b may include a first ground region 1110g and a second ground region 1120g. The first ground region 1110g and the second ground region 1120g may include a first feeding pattern 1110f and a second feeding pattern 1120f configured to feed power to the first transparent antenna 1100-1 and the second transparent antenna 1100-2.

The antenna assembly 1000 may include a slot antenna region 1100s which operates in a Wi-Fi frequency band. The slot antenna region 1100s may be arranged between the first ground region 1110g and the second ground region 1120g. In another example, the slot antenna region 1100s may be arranged on one side of the first ground region 1110g or another side of the second ground region 1120g. The slot antenna region 1100s may include a plurality of slot radiator patterns formed on the first conductive pattern 1110. The radiator patterns arranged in the slot antenna region 1100s may operate as a third antenna 1100-3.

The slot antenna region 1100s may include a plurality of slot regions. The slot antenna region 1100s may include a first slot region 1110s and a second slot region 1120s. The slot antenna region 1100s may further include a third slot region 1130s. The slot antenna region 1100s may be configured to emit Wi-Fi signals of a first frequency band and a second frequency band. The first slot region 1110s may be formed on the first conductive pattern 1110 in a second axial direction. The first slot region 1110s may be configured to be coupled with a signal line 313-1 of a coaxial cable 313.

The third slot region 1120s may be connected to one side of the first slot region 1110s. The second slot region 1120s may include a plurality of sub-slot regions. The second slot region 1120s may include a first sub-slot region 1121s and a second sub-slot region 1122s. The first sub-slot region 1121s may be connected to one side of the first slot region 1110s. The signal line 313-1 of the coaxial cable 313 may be arranged in the second slot region 1120s and a dielectric region 1010d above the first sub-slot region 1121s. The second sub-slot pattern 1122s may be connected to one side of the first sub slot region 1121s. A second width Ws2 of the second sub-slot region 1122s in the first axial direction may be wider than a first width Ws1 of the first sub-slot region 1121s in the first axial direction. A second length Ls2 of the second sub-slot region 1122s in the second axial direction may be longer than a first length Ls1 of the first sub-slot region 1121s in the first axial direction.

The third slot region 1130s may be arranged on another side of the first slot region 1110s. The third slot region 1130s may be formed in a rectangular shape. The third slot region 1130s may be formed in a right triangular shape such that its width increases. A second connection point Ps2 to which the third slot region 1130s is connected may be located at a higher position than a first connection point Ps1 to which the first slot region 1130s connected with the second slot region 1120s is connected.

The slot pattern 1500s which operates as the RF chokes may be arranged on the second dielectric substrate 1010c on which the third antenna 1100-3 as the Wi-Fi antenna is implemented, or on the second dielectric substrate 1010b which feeds power to the first and second transparent antennas 1100-1 and 1100-2.

The slot pattern 1500s may include a first ground region 1110g and a second ground region 1120g of the second dielectric substrate 1010b. Accordingly, signals of the same or adjacent frequency band as or to the Wi-Fi signal may be blocked from being transmitted from the first ground region 1110g and the second ground region 1120g to the slot antenna region 1100s.

The slot pattern 1500s may be formed in the slot antenna region 1100s of the second dielectric substrate 1010b. Accordingly, the Wi-Fi signal of the third antenna 1100-3 may be blocked from being transmitted from the slot antenna region 1100s to the first ground region 1110g and the second ground region 1120g.

Hereinafter, a vehicle including an antenna assembly according to the specification will be described with reference to FIGS. 1A to 18B. In this regard, an antenna operating in a Wi-Fi frequency band may be arranged between the first and second antennas operating in a 4G/5G frequency band. The first and second antennas operating in the 4G/5G frequency band may be implemented as a first transparent antenna 1100-1 and a second transparent antenna 1100-2. The first transparent antenna 1100-1 and the second transparent antenna 1100-2 may be configured to emit wireless signals in a low band (LB), a mid-band (MB), and a high band (HB). The first transparent antenna 1100-1 and the second transparent antenna 1100-2 may perform MIMO in the same frequency band. The antenna operating in the Wi-Fi frequency band may be implemented as a third antenna 1100-3. An RF choke according to the specification may be implemented as a slot pattern 1500s and may reduce interference between signals of the first transparent antenna 1100-1 and the second transparent antenna 1100-2 and the third antenna 1100-3 in the Wi-Fi frequency band.

A glass panel 310 may include a transparent region 311 and an opaque region 312. The antenna assembly 1000 may be arranged on the glass panel 310. The antenna assembly 1000 may include a first dielectric substrate 1010a which is a transparent substrate, and second dielectric substrates 1010b and 1010c which are opaque substrates. The first dielectric substrate 1010a may be disposed on the transparent region 311 of the glass panel 310. A first transparent antenna 1100-1 and a second transparent antenna 1100-2 may be formed on one side surface of the first dielectric substrate 1010a. The second dielectric substrates 1010b and 1010c may include a first ground region 1110g and a second ground region 1110g. The second dielectric substrates 1010b and 1010c may be located in the opaque region 312 of the glass panel 310.

A slot antenna region 1100s which operates in a Wi-Fi frequency band may be formed on the second dielectric substrate 1010c. In some embodiments, an RF choke configured to block signals of the Wi-Fi frequency band according to the specification may include a plurality of conductive patterns and a plurality of slot patterns. In this regard, the antenna assembly 1000 may include an RF choke which includes a first conductive pattern 1510, a second conductive pattern 1520, and a slot pattern 1500s.

The slot pattern 1500s may be arranged between the first ground region 1110g and the second ground region 1120g. The slot pattern 1500s may be configured to reflect a signal of a specific frequency band. The slot pattern 1500s may be implemented as a plurality of slot patterns. The slot pattern 1500s may include a first slot pattern 1510s and a second slot pattern 1520s. The slot pattern 1500s may further include a third slot pattern 1530s.

The first slot pattern 1510s may be formed with a first slot length in the first axial direction, so that the signal of the specific frequency band may be reflected in an opposite direction on the first axis. The second slot pattern 1520s may be connected to the first slot pattern 1510s. The second slot pattern 1520s may be formed with a second slot length in the second axial direction. The third slot pattern 1530s may be formed to connect a point on the inner side of the first slot pattern 1510s or the second slot pattern 1520s and the gap region on the outside of the first conductive pattern 1510.

The slot pattern 1500s of the RF choke according to the specification may be configured to block signals of different frequency bands through additional slot patterns. In some embodiments, the slot pattern 1500s may be configured to block signals of a first frequency band of 2.4 to 2.5 GHz and a second frequency band of 5.15 to 5.85 GHz. The slot pattern 1500s may be configured to further include first to third slot patterns 1510s to 1530s, a fourth slot pattern 1540s, and a fifth slot pattern 1550s. The third slot pattern 1530s may be formed to connect a point of the first slot pattern 1510s and a gap region.

The slot pattern 1500s may include a fourth slot pattern 1540s which is arranged in parallel to the second slot pattern 1520s between the first conductive pattern 1510 and the second slot pattern 1520s. The slot pattern 1500s may be connected to the fourth slot pattern 1540s and may include a fifth slot pattern 1550s which is connected to the fourth slot pattern 1540s and connects a point on the inner side of the fourth slot pattern 1540s and a gap region.

The first conductive pattern 1510 may be configured to include a plurality of sub-patterns. In this regard, the first conductive pattern 1510 may include a first sub-pattern 1511 formed in a first axial direction. The first conductive pattern 1510 may further include a second sub-pattern 1512 which is connected to the first sub-pattern 1511 and formed in a second axial direction perpendicular to the first axial direction. The first slot pattern 1510s to the third slot pattern 1530s may be arranged on the second conductive pattern 1520 which is spaced apart from the outer boundary of the first conductive pattern 1510. The RF choke arranged on the second conductive pattern 1520 formed on the outer side of the first conductive pattern 1510 may be referred to as an outer-form RF choke.

The RF choke may be arranged on the second conductive pattern 1520 formed on the outer side of the first conductive pattern 1510 or on a third conductive pattern 1530 which is formed on the inner side of the first conductive pattern 1510. The RF choke arranged on the third conductive pattern 1530 may be arranged on the third conductive pattern 1530 which is formed on the inner side of the first conductive pattern 1510. The RF choke arranged on the third conductive pattern 1530 formed on the inner side of the first conductive pattern 1510 may be referred to as an inner-form RF choke.

The third conductive pattern 1530 may be formed spaced apart from the inner boundary of the first sub-pattern 1511 and the second sub-pattern 1512 of the first conductive pattern 1510. The first slot pattern 1510s to the third slot pattern 1510s may be arranged on the third conductive pattern 1530 on the inner side of the first conductive pattern 1510 to be spaced apart from the inner boundary of the first conductive pattern 1510.

The RF choke implemented in the antenna assembly may further include a via hole 1500v and a metal stub 1500 ms. The via hole 1500v may be arranged in a region between the second slot pattern 1520s and the third slot pattern 1530s and the gap region. The via hole 1500v may be configured to vertically connect a conductive pattern which is formed on the rear surface of a second dielectric substrate 1010c.

The metal stub 1500 ms may be arranged on the rear surface of the second dielectric substrate 1010c and may be connected to the via hole 1500v. The metal stub 1500 ms may be configured to include a plurality of sub-patterns. In this regard, the metal stub 1500 ms may include a third sub-pattern 1510sb and a fourth sub-pattern 1520sb. The third sub-pattern 1510sb may be arranged on the rear surface of the second dielectric substrate 1010c and connected to the via hole 1500v. The third sub-pattern 1510sb may be formed with a third length Ls3 in the first axial direction. The fourth sub-pattern 1520sb may be connected to the third sub-pattern 1510sb. The fourth sub-pattern 1520sb may be formed with a fourth length Ls4 in the second axial direction.

The via hole 1500v of the outer-form RF choke structure may be arranged between an upper region of the first sub-pattern 1510 and a lower region of the first slot pattern 1510s. The via hole 1500v of the inner-form RF choke structure may be arranged between a lower region of the first sub-pattern 1510 and an upper region of the first slot pattern 1510s.

The second dielectric substrate 1010b of the antenna assembly 1000 may include a first ground region 1110g and a second ground region 1120g. The first ground region 1110g and the second ground region 1120g may include a first feeding pattern 1110f and a second feeding pattern 1120f configured to feed power to the first transparent antenna 1100-1 and the second transparent antenna 1100-2.

The antenna assembly 1000 may include a slot antenna region 1100s which operates in a Wi-Fi frequency band. The slot antenna region 1100s may be arranged between the first ground region 1110g and the second ground region 1120g. In another example, the slot antenna region 1100s may be arranged on one side of the first ground region 1110g or another side of the second ground region 1120g. The slot antenna region 1100s may include a plurality of slot radiator patterns formed on the first conductive pattern 1110. The radiator patterns arranged in the slot antenna region 1100s may operate as a third antenna 1100-3.

The slot antenna region 1100s may include a plurality of slot regions. The slot antenna region 1100s may include a first slot region 1110s and a second slot region 1120s. The slot antenna region 1100s may further include a third slot region 1130s. The slot antenna region 1100s may be configured to emit Wi-Fi signals of a first frequency band and a second frequency band. The first slot region 1110s may be formed on the first conductive pattern 1110 in a second axial direction. The first slot region 1110s may be configured to be coupled with a signal line 313-1 of a coaxial cable 313.

The third slot region 1120s may be connected to one side of the first slot region 1110s. The second slot region 1120s may include a plurality of sub-slot regions. The second slot region 1120s may include a first sub-slot region 1121s and a second sub-slot region 1122s. The first sub-slot region 1121s may be connected to one side of the first slot region 1110s. The signal line 313-1 of the coaxial cable 313 may be arranged in the first slot region 1110s and the first sub-slot region 1121s. The second sub-slot pattern 1122s may be connected to one side of the first sub-slot region 1121s. A second width Ws2 of the second sub-slot region 1121s in the first axial direction may be wider than a first width Ws1 of the first sub-slot region 1121s in the first axial direction. A second length Ls2 of the second sub-slot region 1122s in the second axial direction may be longer than a first length Ls1 of the first sub-slot region 1121s in the first axial direction.

The third slot region 1130s may be arranged on another side of the first slot region 1110s. The third slot region 1130s may be formed in a rectangular shape. The third slot region 1130s may be formed in a right triangular shape such that its width increases. A second connection point Ps2 to which the third slot region 1130s is connected may be located at a higher position than a first connection point Ps1 to which the first slot region 1130s connected with the second slot region 1120s is connected.

The slot pattern 1510 which operates as the RF choke may be arranged on the second dielectric substrate 1010c on which the third antenna 1100-3 as the Wi-Fi antenna is implemented, or on the second dielectric substrate 1010b which feeds power to the first and second transparent antennas 1100-1 and 1100-2.

The slot pattern 1510 may include a first ground region 1110g and a second ground region 1120g of the second dielectric substrate 1010b. Accordingly, signals of the same or adjacent frequency band as or to the Wi-Fi signal may be blocked from being transmitted from the first ground region 1110g and the second ground region 1120g to the slot antenna region 1100s.

The slot pattern 1510 may be formed in the slot antenna region 1100s of the second dielectric substrate 1010b. Accordingly, the Wi-Fi signal of the third antenna 1100-3 may be blocked from being transmitted from the slot antenna region 1100s to the first ground region 1110g and the second ground region 1120g.

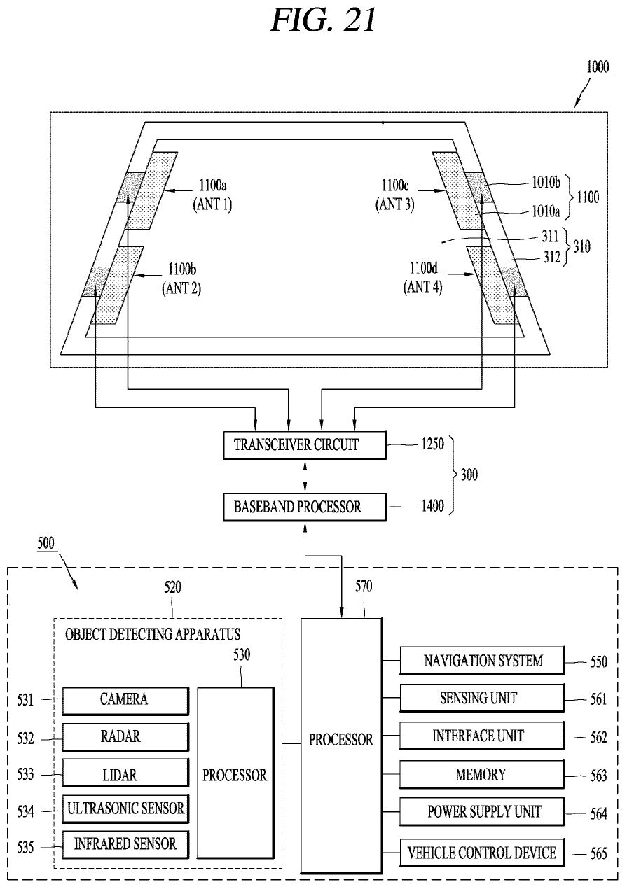

Hereinafter, a vehicle having an antenna module according to one aspect of the specification will be described in detail. In this regard, FIG. 21 is a view of a configuration in which a plurality of antenna modules arranged at different positions of a vehicle are coupled with other components of the vehicle.

Referring to FIGS. 1 to 21, the vehicle 500 may include a conductive vehicle body operating as an electrical ground. The vehicle 500 may include a plurality of antennas 1100a to 1100d which may be located at different positions on a glass panel 310. The antenna assembly 1000 may include the plurality of antennas 1100a to 1100d and a communication module 300. The communication module 300 may include a transceiver circuit 1250 and a processor 1400. The communication module 300 may correspond to the TCU of the vehicle or may constitute at least a portion of the TCU.

The vehicle 500 may include an object detection device 520 and a navigation system 550. The vehicle 500 may further include a separate processor 570 in addition to the processor 1400 included in the communication module 300. The processor 1400 and the separate processor 570 may be physically or functionally separated and may be implemented on one substrate. The processor 1400 may be implemented as a TCU, and the processor 570 may be implemented as an electronic control unit (ECU).

In case where the vehicle 500 is an autonomous vehicle, the processor 570 may be an autonomous driving control unit (ADCU) integrated with an ECU. Based on information detected by a camera 531, radar 532, and/or LiDAR 533, the processor 570 may search for a path and control the vehicle 500 to be accelerated or decelerated. To this end, the processor 570 may interwork with a processor 530 corresponding to a micro control unit (MCU) arranged in the object detection device 520 and/or the communication module 300 corresponding to the TCU.

The vehicle 500 may include a first transparent dielectric substrate 1010a and a second dielectric substrate 1010b arranged on the glass panel 310. The first transparent dielectric substrate 1010a may be formed inside the glass panel 310 of the vehicle or may be attached to the surface of the glass panel 310. The first transparent dielectric substrate 1010a may be configured such that conductive patterns in the shape of metal mesh grids are formed. The vehicle 500 may include an antenna module 1100 having conductive patterns formed in a metal mesh shape on one side of the dielectric substrate 1010a to radiate radio signals.

The antenna assembly 1000 may include a first antenna module 1100a to a fourth antenna module 1100d to perform MIMO. The first antenna module 1100a, the second antenna module 1100b, the third antenna module 1100c, and the fourth antenna module 1100d may be arranged on the upper left, lower left, upper right, and lower right sides of the glass panel 310, respectively. The first antenna module 1100a to the fourth antenna module 1100d may be referred to as a first antenna ANT1 to a fourth antenna ANT4, respectively. The first antenna ANT1 to the fourth antenna ANT4 may be referred to as a first antenna module ANT1 to a fourth antenna module ANT4, respectively.

The first antenna ANT1 to the fourth antenna ANT4 may be implemented as transparent antennas arranged on the first dielectric substrate 1010a and may operate as radiators in a first frequency band to a third frequency band for 4G/5G wireless communication. In another embodiment, the first antenna ANT1 to the fourth antenna ANT4 may be arranged on the second dielectric substrate 1010b and may operate as radiators in a first Wi-Fi frequency band and a second Wi-Fi frequency band. The first Wi-Fi frequency band and the second Wi-Fi frequency band may be set to frequencies in the ranges of 2.4 to 2.5 GHz and 5.15 to 5.85 GHz, but are not limited thereto.

RF chokes configured as slot patterns may be formed on a dielectric substrate which is arranged in the opaque region 312 including the second dielectric substrate 1010b. The RF chokes may be formed as a plurality of slot patterns to reflect (block) signals in the first Wi-Fi frequency band and the second Wi-Fi frequency band. The RF chokes may include first to third slot patterns to reflect signals in the first Wi-Fi frequency band. The RF chokes may include first to fifth slot patterns to reflect signals in the first and second Wi-Fi frequency bands.

As described above, the vehicle 500 may include the telematics control unit (TCU) 300, which corresponds to the communication module. The TCU 300 may control signals to be received and transmitted through at least one of the first to fourth antenna modules 1100a to 1100d. The TCU 300 may include a transceiver circuit 1250 and a processor 1400.

Accordingly, the vehicle may further include the transceiver circuit 1250 and the processor 1400. A portion of the transceiver circuit 1250 may be arranged in units of antenna modules or in combination thereof. The transceiver circuit 1250 may control a radio signal of at least one of first to third frequency bands to be radiated through the antenna modules ANT1 to ANT4. The first to third frequency bands may be an LB band, an MB band, and an HB band for 4G/5G wireless communications, but are not limited thereto.

The processor 1400 may be operably coupled to the transceiver circuit 1250 and may be configured as a modem operating in a baseband. The processor 1400 may receive or transmit a signal through at least one of the first antenna module ANT1 and the second antenna module ANT2. The processor 1400 may perform a diversity operation or MIMO using the first antenna module ANT1 and the second antenna module ANT2 such that a signal is transmitted to the inside of the vehicle.

Antenna modules may be arranged in different regions of one side surface and another side surface of the glass panel 310. The antenna modules may perform MIMO by simultaneously receiving signals from the front of the vehicle. In this regard, to perform 4×4 MIMO, the antenna modules may further include the third antenna module ANT3 and the fourth antenna module ANT4 in addition to the first antenna module ANT1 and the second antenna module ANT2.

The processor 1400 may select an antenna module to perform communication with an entity communicating with the vehicle based on a driving path of the vehicle and a communication path with the entity. The processor 1400 may perform MIMO by using the first antenna module ANT1 and the second antenna module ANT2 based on a direction that the vehicle travels. Alternatively, the processor 1400 may perform MIMO through the third antenna module ANT2 and the fourth antenna module ANT4 based on the direction that the vehicle travels.

The processor 1400 may perform MIMO in a first band through at least two of the first antenna ANT1 to the fourth antenna ANT4. The processor 1400 may perform MIMO in at least one of a second band and a third band through at least two of the first antenna ANT1 to the fourth antenna ANT4.

Accordingly, when signal transmission/reception performance of the vehicle deteriorates in any one band, signal transmission/reception in the vehicle may be performed in other bands. For example, the vehicle may preferentially perform communication linkage in the first band, which is the low band, for wide communication coverage and linkage reliability, and then perform communication linkage in the second and third bands.

The processor 1400 may control the transceiver circuit 1250 to perform carrier aggregation (CA) or dual connectivity (DC) through at least one of the first antenna ANT1 to the fourth antenna ANT4. In this regard, a communication capacity may be expanded through the aggregation of the second band and the third band, which are wider than the first band.

Communication reliability can be improved through the DC with neighboring vehicles or entities by using the plurality of antenna elements arranged in the different regions of the vehicle.

The above description has been given of the interference reduction structure including the RF chokes implemented with slot patterns that reduce interference between antenna elements in an antenna assembly that may be arranged on vehicle glass. Hereinafter, the technical effects of the interference reduction structure including the RF chokes implemented with slot patterns that reduce interference between antenna elements in an antenna assembly that will be described.

According to the specification, interferences between antennas may be reduced through an RF-choke structure implemented with slot patterns in a broadband transparent antenna assembly which may be arranged on vehicle glass.

According to the specification, a Wi-Fi antenna structure, which may coexist with a transparent antenna, and an interference reduction structure including RF chokes implemented with slot patterns may be provided by considering the arrangement structure of the transparent antenna arranged on vehicle glass.

According to the specification, a two-dimensional RF Choke structure may be provided that is designed to be smaller than existing RF chokes and is implemented to be operable bidirectionally on a two-dimensional plane.

According to the specification, an RF-choke structure operable in a single Wi-Fi frequency band may be implemented by a combination of first and second slot patterns or a combination of first to third slot patterns.

According to the specification, an RF-choke structure capable of operating in a dual Wi-Fi frequency band may be implemented by combining fourth and fifth slot patterns with a structure capable of operating in a single frequency band.

According to the specification, two-dimensional RF choke structures may be provided at corners of ground regions adjacent to feeding patterns, taking into account isolation according to a current flow between a 4G/5G MIMO antenna and a Wi-Fi antenna.

According to the specification, an RF choke arrangement structure which is capable of improving the performance of the Wi-Fi antenna through the two-dimensional RF choke structures at the corners of the ground regions can be provided.

Further scope of applicability of the disclosure will become apparent from the following detailed description. It should be understood, however, that further scope of applicability of the disclosure will become apparent from the following detailed description because various changes and modifications within the technical idea and scope of the disclosure will be apparent to those skilled in the art. It should be understood, however, that the detailed description and specific examples, such as the preferred embodiments, are given by way of illustration only, because various changes and modifications within the technical idea and scope of the disclosure will be apparent to those skilled in the art.

In relation to the aforementioned disclosure, the design and operations of an antenna assembly having transparent antennas and a vehicle controlling the same may be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

1. A vehicle comprising:
a glass panel comprising a transparent region and an opaque region; and
an antenna assembly arranged on the glass panel,
wherein the antenna assembly comprises:
a first dielectric substrate arranged in the transparent region of the glass panel, and comprising a transparent antenna formed on one side surface thereof;
a second dielectric substrate arranged in the opaque region of the glass panel;
a first conductive pattern formed on the second dielectric substrate;
a second conductive pattern formed by being spaced apart from an outer boundary of the first conductive pattern or an inner boundary of the first conductive pattern by a gap region; and
a slot pattern arranged parallel to the outer boundary of the first conductive pattern or the inner boundary of the first conductive pattern and configured to reflect a signal of a specific frequency band,
the slot pattern comprises:
a first slot pattern formed with a first slot length in a first axial direction and configured to reflect the signal in an opposite direction on the first axis;
a second slot pattern connected to the first slot pattern and formed with a second slot length in the second axial direction; and
a third slot pattern connecting a point on an inner side of the first slot pattern or the second slot pattern and the gap region.

2. The vehicle of claim 1, wherein the third slot pattern is formed to connect a point of the first slot pattern and the gap region, and
the slot pattern further comprises:
a fourth slot pattern arranged parallel to the second slot pattern between the first conductive pattern and the second slot pattern; and
a fifth slot pattern connecting a point on an inner side of the fourth slot pattern and the gap region.

3. The vehicle of claim 1, wherein the first conductive pattern comprises a first sub-pattern formed in the first axial direction, and a second sub-pattern connected to the first sub-pattern and formed in the second axial direction, and
the first slot pattern to the third slot pattern are arranged on the second conductive pattern spaced apart from the outer boundary of the first conductive pattern.

4. The vehicle of claim 1, wherein the first conductive pattern comprises a first sub-pattern formed in the first axial direction, and a second sub-pattern connected to the first sub-pattern and formed in the second axial direction,
the conductive pattern further comprises a third conductive pattern formed spaced apart from inner boundaries of the first sub-pattern and the second sub-pattern, and
the first slot pattern to the third slot pattern are arranged on the third conductive pattern spaced apart from the inner boundary of the first conductive pattern.

5. The vehicle of claim 3, wherein the antenna assembly comprises:
a via hole arranged in a region between the second slot pattern and the third slot pattern and the gap region, and vertically connecting a conductive pattern formed on a rear surface of the second dielectric substrate; and
a metal stub arranged on the rear surface of the second dielectric substrate and connected to the via hole, and
the metal stub comprises:
a third sub-pattern formed with a third length in the first axial direction; and
a fourth sub-pattern connected to the third sub-pattern and formed with a fourth length in the second axial direction.

6. The vehicle of claim 5, wherein the via hole is arranged between an upper region of the first sub-pattern and a lower region of the first slot pattern.

7. The vehicle of claim 5, wherein the via hole is arranged between a lower region of the first sub-pattern and an upper region of the first slot pattern.

8. The vehicle of claim 1, wherein the transparent antenna comprises a first transparent antenna and a second transparent antenna,
the second dielectric substrate comprises:
a first ground region and a second ground region comprising a first feeding pattern and a second feeding pattern configured to feed power to the first transparent antenna and the second transparent antenna; and
a slot antenna region arranged between the first ground region and the second ground region and comprising a plurality of slot radiator patterns formed on the first conductive pattern, and
the plurality of slot radiator patterns arranged in the slot antenna region operate as a third antenna.

9. The vehicle of claim 8, wherein the slot antenna region comprises:
a first slot region formed in the second axial direction on the first conductive pattern and configured to be coupled with a signal line of a coaxial cable; and
a second slot region connected to one side of the first slot region and formed in the first axial direction, and
the slot antenna region is configured to radiate Wi-Fi signals of a first frequency band and a second frequency band.

10. The vehicle of claim 8, wherein the slot pattern is formed in the first ground region and the second ground region to suppress a signal of the same band as Wi-Fi signal from being transmitted from the first ground region and the second ground region to the slot antenna region, and
the slot pattern is formed in the slot antenna region to block the Wi-Fi signal from being transmitted from the slot antenna region to the first ground region and the second ground region.

11. A vehicle comprising:
a glass panel comprising a transparent region and an opaque region; and
an antenna assembly arranged on the glass panel,
wherein the antenna assembly comprises:
a first dielectric substrate arranged in the transparent region of the glass panel, and comprising a first transparent antenna and a second transparent antenna formed on one side surface thereof;
a second dielectric substrate comprising a first ground region and a second ground region, and arranged in the opaque region of the glass panel; and
a slot pattern arranged on a conductive pattern of the first ground region and the second ground region, and configured to reflect a signal of a specific frequency band, and
the slot pattern comprises:
a first slot pattern formed with a first slot length in a first axial direction and configured to reflect the signal in an opposite direction on the first axis;
a second slot pattern connected to the first slot pattern and formed with a second slot length in a second axial direction; and
a third slot pattern connecting a point on an inner side of the first slot pattern or the second slot pattern and a gap region.

12. The vehicle of claim 11, wherein the third slot pattern is formed to connect a point of the first slot pattern and the gap region,
the slot pattern further comprises
a fourth slot pattern arranged parallel to the second slot pattern between a first conductive pattern and the second slot pattern; and
a fifth slot pattern connecting a point on an inner side of the fourth slot pattern and the gap region.

13. The vehicle of claim 12, wherein the first conductive pattern comprises a first sub-pattern formed in the first axial direction, and a second sub-pattern connected to the first sub-pattern and formed in the second axial direction, and
the first slot pattern to the third slot pattern are arranged on a second conductive pattern spaced apart from the outer boundary of the first conductive pattern.

14. The vehicle of claim 1211, wherein the first conductive pattern comprises a first sub-pattern formed in the first axial direction, and a second sub-pattern connected to the first sub-pattern and formed in the second axial direction, and
the conductive pattern further comprises a second conductive pattern and a third conductive pattern formed spaced apart from outer boundaries and inner boundaries of the first sub-pattern and the second sub-pattern, and
the first slot pattern to the third slot pattern are arranged on the third conductive pattern spaced apart from the inner boundary of the first conductive pattern.

15. The vehicle of claim 13, wherein the antenna assembly comprises:
a via hole arranged in a region between the second slot pattern and the third slot pattern and the gap region, and vertically connecting a conductive pattern formed on a rear surface of the second dielectric substrate; and
a metal stub arranged on the rear surface of the second dielectric substrate and connected to the via hole, and
the metal stub comprises:
a first metal stub formed with a first stub length in the first axial direction; and
a second metal stub connected to the first metal stub and formed with a second stub length in the second axial direction.

16. The vehicle of claim 15, wherein the via hole is arranged between an upper region of the first sub-pattern and a lower region of the first slot pattern.

17. The vehicle of claim 15, wherein the via hole is arranged between a lower region of the first sub-pattern and an upper region of the first slot pattern.

18. The vehicle of claim 1241, wherein the second dielectric substrate comprises:
the first ground region and the second ground region comprising a first feeding pattern and a second feeding pattern configured to feed power to the first transparent antenna and the second transparent antenna; and
a slot antenna region arranged between the first ground region and the second ground region and comprising a plurality of slot radiator patterns, and
the plurality of slot radiator patterns arranged in the slot antenna region operate as a third antenna.

19. The vehicle of claim 18, wherein the slot antenna region comprises:
a first slot region formed in the second axial direction on the first conductive pattern and configured to be coupled with a signal line of a coaxial cable; and
a second slot region connected to one side of the first slot region and formed in the first axial direction, and
the slot antenna region is configured to radiate Wi-Fi signals of a first frequency band and a second frequency band.

20. The vehicle of claim 1811, wherein the slot pattern is formed in the first ground region and the second ground region to suppress Wi-Fi signal from being transmitted from the first ground region and the second ground region to the slot antenna region, and
the slot pattern is formed in the slot antenna region to block the Wi-Fi signal from being transmitted from the slot antenna region to the first ground region and the second ground region.
